(19) United States
(12) Patent Application Publication
(10) Pub. No.: US 2014/0249850 A1
(43) Pub. Date: Sep. 4, 2014

(54) CRITICAL CONDITION MODULE

(71) Applicants: James Thomas Woodson, Longview, TX (US); John Timothy DiPasquale, Longview, TX (US); Stanley Dean Upchurch, Longview, TX (US); Christopher Laird Dunnahoo, Longview, TX (US); Faber Allen White, Longview, TX (US); Justin Dale Schaper, Plano, TX (US)

(72) Inventors: James Thomas Woodson, Longview, TX (US); John Timothy DiPasquale, Longview, TX (US); Stanley Dean Upchurch, Longview, TX (US); Christopher Laird Dunnahoo, Longview, TX (US); Faber Allen White, Longview, TX (US); Justin Dale Schaper, Plano, TX (US)

(21) Appl. No.: 13/782,860

(22) Filed: Mar. 1, 2013

(51) Int. Cl. G06F 19/00; G06Q 50/24

(52) U.S. Cl. CPC G06F 19/3481; G06Q 50/24
USPC 705/3

(57) ABSTRACT

Technologies for medical information and scheduling communication determining a patient condition of a person presently experiencing the condition, determining a timeline, indicating the timeline, receiving real-time information regarding the condition, and updating the timeline. The timeline illustrates time lapsed since an initialization of treatment tracking, a recommended treatment of the patient condition, a treatment time necessary for effective application of the treatment for the patent condition, and an average time of treatment.

### TECHNICAL FIELD OF THE INVENTION

The present invention relates generally to medical informatics and, more particularly, to a critical condition module.

### BACKGROUND

Medical informatics includes cross-disciplined application of computer science, information technology, and healthcare. Medical informatics solutions include providing methods, resources, and devices to facilitate the care of patients by doctors and nurses who have needs to use acquisition, storage, retrieval, and use of information. Many medical informatics solutions use off-the-shelf tools for information technology components, such as servers, communication protocols, data storage, processing, and imaging.

Medical informatics may include processing of electronic health records (EHR). EHRs may be designed for use by health care providers to record data and may be dissimilar to personal health records (PHR). An EHR may be generated and owned by a healthcare provider, though a patient may have legal or privacy rights in the EHR. Data in a PHR may be owned by the patient. Furthermore, an EHR may be available through a patient portal, which may merely give a patient access to a healthcare entity's medical informatics systems to see an EHR pertaining to the patient.

### SUMMARY

In one embodiment, a method for medical information communication includes determining a patient condition of a person presently experiencing the condition, determining a timeline, indicating the timeline, receiving real-time information regarding the condition, and updating the timeline. The timeline illustrates time lapsed since an initialization of treatment tracking, a recommended treatment of the patient condition, a treatment time necessary for effective application of the treatment for the patent condition, and an average time of treatment.

In another embodiment, a system for medical information communication includes a processor, a computer readable medium communicatively coupled to the processor, and computer-executable instructions carried on the computer readable medium. The instructions are readable by the processor. The instructions, when read and executed, cause the processor to determine a patient condition of a person presently experiencing the condition, determine a timeline indicate the timeline, receive real-time information regarding the condition, and update the timeline. The timeline illustrates time lapsed since an initialization of treatment tracking, a recommended treatment of the patient condition, a treatment time necessary for effective application of the treatment for the patent condition, and an average time of treatment.

In yet another embodiment, an article of manufacture includes a computer readable medium and computer-executable instructions carried on the computer readable medium. The instructions are readable by a processor. The instructions, when read and executed, cause the processor to determine a patient condition of a person presently experiencing the condition, determine a timeline indicate the timeline, receive real-time information regarding the condition, and update the timeline. The timeline illustrates time lapsed since an initialization of treatment tracking, a recommended treatment of the patient condition, a treatment time necessary for effective application of the treatment for the patent condition, and an average time of treatment.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an example embodiment of a system for medical information tracking;

FIG. 2 illustrates the operation of an example embodiment of a system for medical information tracking;

FIG. 3 is a more detailed view of an example embodiment of server application;

FIG. 4 illustrates an example embodiment of patient application;

FIG. 5 illustrates an example templatized communication view;

FIG. 6 illustrates an example embodiment of a view including options for a user to indicate readiness;

FIG. 7 illustrates an example embodiment of a view including options for a patient to enter regarding assistance;

FIG. 8 illustrates an example embodiment of a view including options for a user to indicate symptom;

FIG. 9 illustrates an example embodiment of a view including options for a user to indicate needs

FIG. 10 illustrates a body map configured to provide a patient the ability to indicate where symptoms are appearing;

FIG. 11 illustrates an example embodiment of a conversation view;

FIG. 12 illustrates an example embodiment of a caregiver application;

FIG. 13 illustrates an example embodiment of an emergency medical service application;

FIG. 14 illustrates an example embodiment of an add patient module;

FIG. 15 illustrates of an example embodiment of a communications module;

FIG. 16 illustrates an example embodiment of a method for medical information tracking;

FIG. 17 is an illustration of an example embodiment of a system configured to provide condition-specific information tracking;

FIG. 18 illustrates an example embodiment of a main menu view;

FIG. 19 is an illustration of an embodiment of a view for logging in users to a critical condition module;

FIG. 20 is an illustration of an embodiment of a view for setting up an instance of a critical condition module;

FIG. 21 is an illustration of an embodiment of a view for setting up a new instance of a patient treatment;

FIG. 22 is an illustration of an embodiment of a view for obtaining an EKG;

FIG. 23 is an illustration of a view of an instance of an active treatment of a patient;

FIG. 24 is an illustration of a view for halting the monitoring of an active treatment of a patient using critical condition module;

FIG. 25 is an illustration of a view of another instance of an active treatment of a patient using critical condition module;

FIG. 26 is an illustration of a view for ending operation;

FIG. 27 is an illustration of an example embodiment of a method for performance of critical condition monitoring and evaluation;

FIG. 28 is an illustration of example operation of a system configured to provide alerts in conjunction with condition-specific information tracking; and

FIG. 29 is an illustration of example operation of a method for providing alerts in conjunction with condition-specific information tracking.

### DETAILED DESCRIPTION

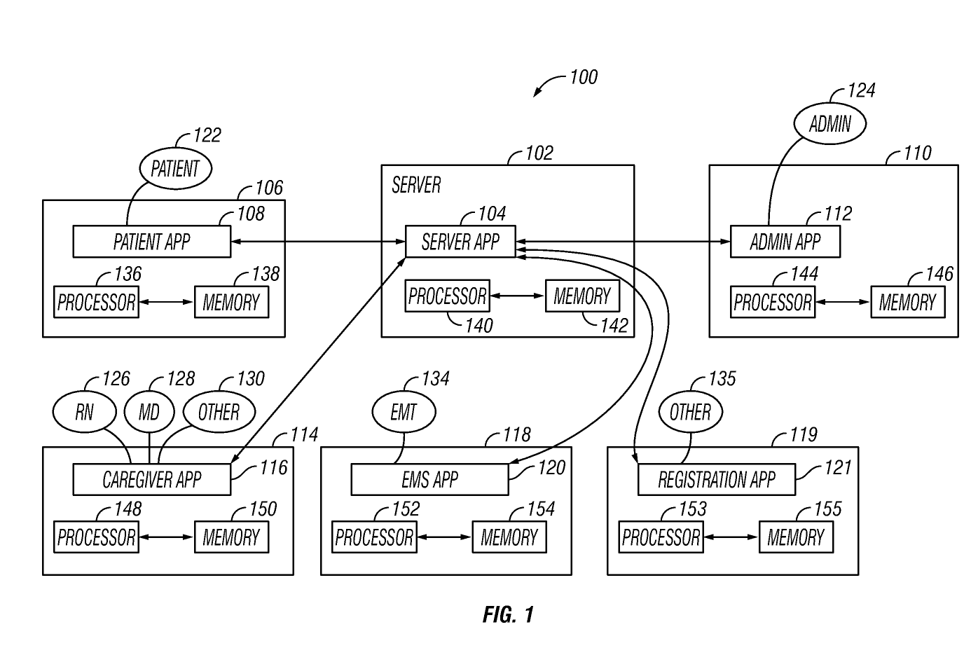

FIG. 1 illustrates an example embodiment of a system 100 for medical information tracking. In one embodiment, operation of system 100 may include a patient initiated distribution of a personal health record (PHR) to one or more other users of system 100.

System 100 may include the distributed or consolidated operation of one or more applications, such as patient application 108, server application 104, admin application 112, caregiver application 116, emergency medical service (EMS) application 120, or registration application 121. Each such application may be operating on different electronic devices 102, 106, 110, 114, 118, 119. Information collected, generated, or otherwise produced by one of patient application 108, admin application 112, caregiver application 116, EMS application 120, or registration application 121 may be communicated to another such application through server application 104. Server application 104 may be configured to store such communication, determine recipients, send messages, and provide additional information to such applications. Any suitable combination of number, particular implementations, or kinds of patient application 108, server application 104, admin application 112, caregiver application 116, EMS application 120, or registration application 121 may be used within system 100.

A given one of patient application 108, server application 104, admin application 112, caregiver application 116, EMS application 120, or registration application 121 may be configured to be used by a class or subclass of user. For example, patient application 108 may be configured to be used by a patient 122. Caregiver application 116 may be configured to be used by a nurse 126, doctor 128, or other 130 medical professional. The particular instance of caregiver application 116 may be configured to be conformed to a particular kind of users, such as nurse 126 versus doctor 128. Such configuration may include selective use or employment of particular features specific to, for example, a nurse or a doctor. EMS application 120 may be configured to be used by an emergency medical technician (EMT) 124. Server application 104 may be configured to be controlled by an administrator 124 of system 100 through, for example, admin application 112. Registration application 121 may be configured to be used by an other 130 medical professional, such as a supervisor, emergency room administrator, doctor, or nurse. The selective configuration of each of the applications for a given user may be made by, for example, altering the options and features presented to a specific or class of users.

Each of patient application 108, server application 104, admin application 112, caregiver application 116, EMS application 120, and registration application 121 may be implemented in unique, similar, or separate manners. For example, each such application may be executed out of a single codebase modified during execution for a particular user. In another example, each such application may represent a different codebase. Each of patient application 108, server application 104, admin application 112, caregiver application 116, EMS application 120, and registration application 121 may be implemented in any suitable fashion, such as by modules, logic, instructions, executables, libraries, functions, scripts, applications, hardware, software, firmware, input/output mechanisms, displays, views, or any suitable combination thereof. In one embodiment, some or all of each of patient application 108, server application 104, admin application 112, caregiver application 116, EMS application 120, and registration application 121 may be implemented by instructions or logic in a computer-readable medium or memory. The instructions may be executable by a processor and, when executed, perform the functionality described herein. Execution by the processor may cause one or more changes within the processor, such as to encoders, decoders, caches, or registers.

Communication between patient application 108, admin application 112, caregiver application 116, EMS application 120, registration application 121, and server application 104 may be made through any suitable connection, such as by a wireless or wired network. Such networks may include or use, for example, an intranet, the Internet, mobile phone or cellular networks, 802.11 class communications, text, transport control protocol, Internet protocol, hypertext transfer protocol, Ethernet, or any other suitable mechanism. Such networks and protocols may be secured according to ethical and legal requirements to protect patient privacy. In one embodiment, unsecure methods, such as short messaging service (SMS) texts, may be insufficiently secure and thus not used.

Each of electronic devices 106, 102, 110, 114, 118, 119 may be implemented in any suitable manner, such as by a server, computer, laptop, mobile phone, tablet, or other suitable electronic entity. Each of electronic devices 106, 102, 110, 114, 118, 119 may include a respective processor 136, 140, 144, 148, 152, 153 communicatively coupled to a respective memory 138, 142, 146, 150, 154, 155. In one embodiment, each of patient application 108, server application 104, admin application 112, caregiver application 116, EMS application 120, and registration application 121 may be resident fully or partially within respective memories 138, 142, 146, 150, 154, 155 and executed by respective processors 136, 140, 144, 148, 152, 153.

Processors 136, 140, 144, 148, 152, 153 may comprise, for example, a microprocessor, microcontroller, digital signal processor (DSP), application specific integrated circuit (ASIC), or any other digital or analog circuitry configured to interpret and/or execute program instructions and/or process data. In some embodiments, processors 136, 140, 144, 148, 152, 153 may interpret and/or execute program instructions and/or process data stored in memories 138, 142, 146, 150, 154, 155. Memories 138, 142, 146, 150, 154, 155 may be configured in part or whole as application memory, system memory, or both. Memories 138, 142, 146, 150, 154, 155 may include any system, device, or apparatus configured to hold and/or house one or more memory modules. Each memory module may include any system, device or apparatus configured to retain program instructions and/or data for a period of time (e.g., computer-readable storage media).

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (“RAM”), read-only memory (“ROM”), electrically erasable programmable read-only memory (“EEPROM”), and/or flash memory; as well as communications media such as wires, optical fibers, microwaves, radio waves, and other electromagnetic and/or optical carriers; and/or any combination of the foregoing.

A PHR may include a combination of information associated with a given patient. The information associated with a PHR may be controlled, directed, or owned by the patient, as opposed to a medical entity that may perform medical services or generate medical data. In system 100, all interactions with or actions of a given user through, for example, the patient's instance of patient application 108 may be logged to the PHR. Such a running log may include a continuing document of care (CDC), or a continuity of care document (CCD). Furthermore, a PHR may include electronic medical records (EMR) that have been received from various entities, such as individual hospitals, doctor's offices, or nursing homes. Such EMRs may be submitted to system 100 and added to a given PHR. Furthermore, live data collected on symptoms from a caregiver, patient, or medical device may be included in a PHR. In addition, communications between entities in system 100 regarding a patient may be included in the associated PHR. Other information, such as health history, current medical problems, past medical problems, immunization history, social history, family medical history, preferences, vital statistics, medications, previous medical data, lab results, or other medical information for a patient may be included in the associated PHR. Different portions or data of a PHR may be affirmed, updated, or verified from time-to-time. Such affirmation may be performed by, for example, the patient themselves or a caregiver. Consequently, the timeliness of the information within PHR may be noted by timestamps, verification metadata, or other mechanisms within the PHR itself.

A PHR may be implemented in any suitable manner. In one embodiment, a PHR may be defined with various fields and information according to an extensible markup language (XML) scheme. In another embodiment, a PHR may be defined according to various fields of a database.

In system 100, a patient may control disbursement of information within an associated PHR to various other entities. Furthermore, the patient may be able to selectively disburse portions of the associated PHR. Caregivers, EMTs, and other parties may be required to receive PHR information from centralized control of system 100, which gets its authorization for disbursement from the patient. Information may thus flow from one non-patient party to another by logging and selective disbursement by system 100, rather than direct communication between the parties.

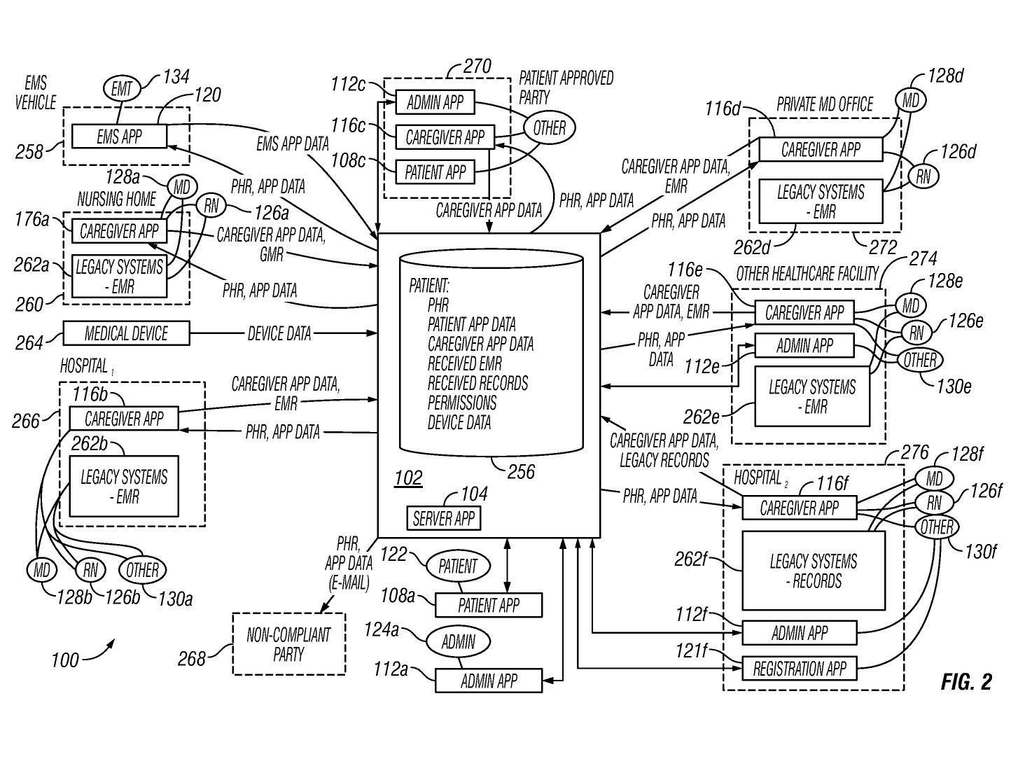

FIG. 2 illustrates the operation of an example embodiment of a system 100 for medical information tracking FIG. 2 illustrates various more detailed examples of instances of elements of system 100 and their operation.

Patient 122 may be using patient application 108a to access system 100. Patient application 108a may authorize use of a PHR for patient 122 in system 100 and selective access for one or more other users of system 100. Authorization of the use of data may include express authorization for particular users of system 100 to receive selections from the PHR. Upon receipt of authorization, server application 104 may be configured to push information such as the PHR to necessary application recipients. Server application 104 operating on server 102 may manage the medical information tracking for patient 122 and coordinate communication with other applications, including selectively sending medical information, such as the PHR, of patient 122 to other these applications. Furthermore, admin 124a may be using admin app 112a to operate, manager, or otherwise control system 100.

EMT 134 may be using an instance of EMS application 120 on an electronic device such as one in an EMS vehicle 258. EMS application 120 may transmit application data to server application 104, and receive pertinent data in return.

Doctor 128a or nurse 126a may be using an instance of caregiver application 116a at a nursing home 260. Furthermore, access may be made of legacy systems 262a which may include information such as an electronic medical record (EMR). Caregiver application 116a may transmit application information, as well as information such as the EMR from legacy systems 262a to server application 104. In return, server application 104 may send information in reply such as selections from patient's 122 PHR, or application data from other applications.

A medical device 264 may be configured to supply information to server application 104. Medical device 264 may be gathering information on, for example, patient 122. Medical device 264 may include, for example, an IV, a monitor, a breathing machine, scale, glucometer, blood pressure monitor, pulse monitor, oximeter, or any other suitable healthcare instrument. Server application 104 may be configured to update the PHR with the information in real-time. Furthermore, server application 104 may be configured to selectively provide the information as part of the PHR to one or more authorized users of system 100.

Doctor 128b, nurse 126b, or other party 130a may be using an instance of caregiver application 116b at a first hospital. Furthermore, access may be made of legacy systems 262b which may include information such as an EMR. Caregiver application 116b may transmit application information, as well as information such as the EMR from legacy systems 262b to server application 104. In return, server application 104 may send information in reply such as selections from patient's 122 PHR, or application data from other applications.

A non-compliant party 268 may include any entity that is not configured to interoperably or interactively exchange information with server application 104. Such a non-compliant party may include healthcare facilities, caregivers, companies, or other entities that operate only legacy or incompatible health informatics systems. Furthermore, a non-compliant party 268 may include other parties that a patient may wish to send medical information, such as friends or family members. Information may be configured to be sent in a generally accessible format, such as a document in portable data format (PDF). Such a document may be secured using, for example, a password. The password may be set by, for example, a patient who has initiated the transmission of information to non-compliant party 268. Server application 104 may be configured to provide information to a designated non-compliant party 268 through, for example, asynchronous methods such as mail or e-mail messages.

Yet another patient approved party 270, of any suitable kind or variation, may utilize an instance of admin application 112c, caregiver application 116c, or patient application 108c, or any combination thereof. Patient approved party 270 may include an entity to which patient 122, admin 124a, or a caregiver has delegated authority or responsibility. Patient-approved party 270 may transmit application information to server application 104. In return, server application 104 may send information in reply such as selections from patient's 122 PHR, or application data from other applications

Doctor 128d or nurse 126d may be using an instance of caregiver application 116d at a private medical doctor's (MD) office 272. Furthermore, access may be made of legacy systems 262d, which may include information such as an EMR. Caregiver application 116d may transmit application information, as well as information such as the EMR from legacy systems 262d to server application 104. In return, server application 104 may send information in reply such as selections from patient's 122 PHR, or application data from other applications.

Doctor 128e, nurse 126e, or another party 130e may be using an instance of caregiver application 116e or admin application 112e at a healthcare facility of another, varying type such as a laboratory, outpatient center, urgent care clinic, or testing facility. Furthermore, access may be made of legacy systems 262e which may include information such as an EMR. Caregiver application 116e or admin application 112e may transmit application information, as well as information such as the EMR from legacy systems 262e to server application 104. In return, server application 104 may send information in reply such as selections from patient's 122 PHR, or application data from other applications.

Doctor 128f, nurse 126f, or another party 130f may be using an instance of registration application 121f, caregiver application 116f, or admin application 112f at a second hospital 276. Furthermore, access may be made of legacy systems 262f which may include information such as legacy records. Legacy records of legacy systems 262f may be incompatible or of a different type than, for example, EMR of legacy systems 262b. Caregiver application 116f or admin application 112f may transmit application information, as well as information such as records from legacy systems 262f to server application 104. In return, server application 104 may send information in reply such as selections from patient's 122 PHR, or application data from other applications. Users at another facility, such as hospital 266, may utilize instances of, for example, caregiver application 116b, to view the records from legacy systems 262f that have been transmitted to server application 104. Likewise, instances of caregiver application 116f may be configured to view the records from legacy systems 262b such as an EMR. Registration application 121f may determine whether a patient has completed registration information for admittance to or treatment by the facility. Furthermore, one or more of caregiver application 116f or registration application 121f may be in communication with server application 104 to monitor patients who are en-route to hospital 276, or who have already arrived at hospital 276. Registration application 121f may determine the wait times, triage information, hospital forms and intake documentation status, admittance and discharge status, facility capacity, and other information regarding a given patient.

Server application 104 may be communicatively coupled to a PHR database 256. PHR database 256 may reside on server 102 or on any other suitable electronic device. PHR database 256 may organize information on a per-patient basis. PHR database 256 may include assembled received application data from applications of system 100 in a PHR for the patient. Furthermore, PHR database 256 may include data received from legacy systems such as records or EMRs. In addition, PHR database 256 may include permissions from an associated patient determining how information for the patient may be disbursed to applications of system 100. Furthermore, PHR database 256 may include device data received from various medical devices associated with a patient.

PHR database 256 may be implemented in any suitable manner. For example, PHR database 256 may be implemented by a database, files, data structures, or any other suitable entity. Furthermore, PHR database 256 may be implemented on any suitable electronic device or system, such as a server farm, cloud service, or storage array. PHR database 256 may include or may be communicatively coupled to storage service software configured to efficiently store, serve, and maintain its information. Information may be input into PHR database 256 from any suitable entity, such as patient application 108, admin application 110, caregiver application 116, EMS application 118, or registration 121. Furthermore, information may be input into PHR database 256 from, for example, other databases, legacy databases, medical devices, servers, cameras, scanners, or other suitable devices.

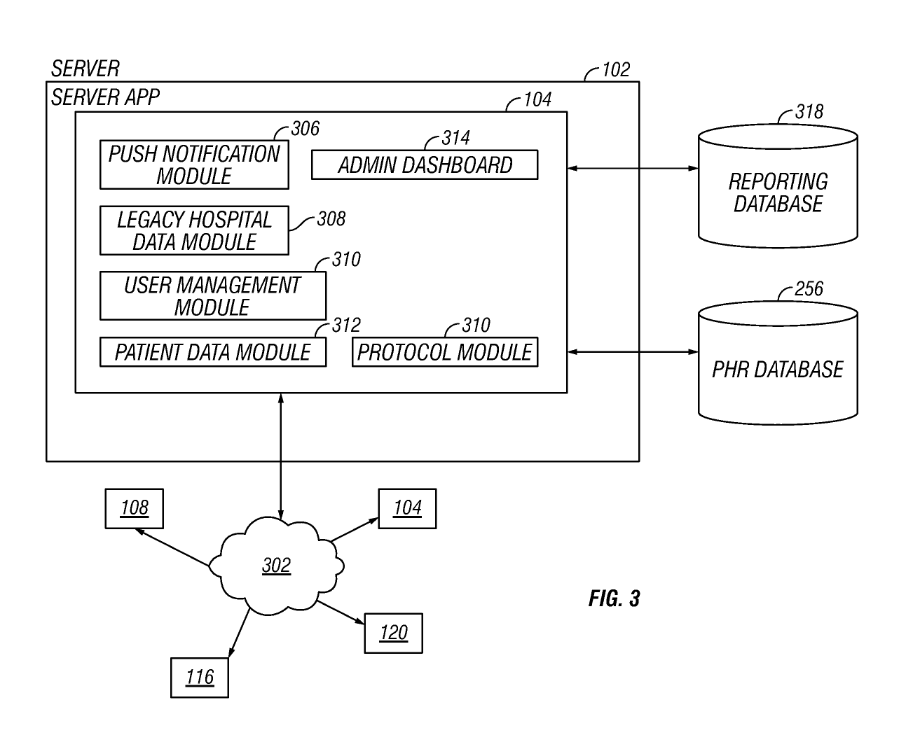

FIG. 3 is a more detailed view of an example embodiment of server application 104.

Server application 104 may include any suitable number, kind, or combination of components to perform the functionality described herein. For example, server application 104 may include a push notification module 306, legacy hospital data module 308, user management module 310, patient data module 312, admin dashboard 314, or protocol module 316. Each of push notification module 306, legacy hospital data module 308, user management module 310, patient data module 312, admin dashboard 314, and protocol module 316 may be implemented by any suitable application, script, executable, logic, instructions, functions, hardware, software, firmware, input/output mechanisms, displays, views, or any suitable combination thereof.

Push notification module 306 may be configured to determine consumers or recipients of information, such as selective portions of a patient's PHR, and to send the information or an indicator of the information to the recipient. Such recipients may include caregiver 116, patient 108, EMS 120, or admin 112 applications. Such information may be sent using, for example, text, SMS, hypertext transmission protocol (HTTP), file transfer protocol, transport control protocol, internet protocol, or any other suitable electronic manner.

Legacy hospital data module 308 may be configured to translate, store, retrieve, or otherwise handle information from systems not compliant, integrated, or included within system 100. Such information may be received by server application 104 from various application instances in system 100. Legacy hospital data module 308 may be configured to selectively include relevant portions of such information and attach or associate the portions with a patient's PHR.

User management module 310 may be configured to track, manage, or otherwise handle users of system 100. User management module 310 may define permissions, handle data transactions, set on-call or on-duty notices, or determine personnel who are on-duty or on-call for caregivers such as EMTs, nurses, or doctors, or patients.

Patient data module 312 may be configured to track, manage, or otherwise handle patients of system 100. Patient data module 310 may be configured to control access to a patient's PHR or other information.

Admin dashboard 314 may be configured to provide a view and options for an administrator of system 200 to perform maintenance, set preferences, make manual adjustments, or perform other supervisory tasks.

Protocol module 316 may be configured to translate, interpret, or otherwise communicate with various disparate portions of system 100. Protocol module 316 may define technical and policy requirements for encryption, authentication, or privacy to be used in accordance with data transactions of system 100. Furthermore, protocol module 316 may be configured to define how medical information may be defined and translated between different formats.

For example, protocol module 316 may be configured to determine medical information defined according to Health Level Seven (HL7) definitions that may be used in messages to convey a medical status, or in commands for logical operation between applications such as instances of caregiver application 116. Such HL7 information may be wrapped by protocol module 316 with a query control wrapper defining how the underlying information is represented and may be used. Furthermore, such query control data may itself be wrapped by protocol module 316 in a transmission wrapper, configured to include constructs for message identification, addressing (such as an intended application target or source), etc. In addition, information within such a transmission wrapper may be wrapped into general data exchange structure protocol layers, such as extensible markup language (XML) or Simple Object Access Protocol (SOAP). Such data may itself be wrapped into transportation protocol layers, such as TCP/IP or HTTP.

Each of caregiver 116, patient 108, EMS 120, registration 121, or admin 112 applications may implement a protocol module similar to protocol module 316 and configured to facilitate, transmit, and translate medical information and operational commands.

Server application 104 may be communicatively coupled to one or more databases, such as PHR database 256 or reporting database 318. Reporting database 318 may be configured to store an indication of actions taken by server application 104 for a given patient, system actions taken by server applications, or settings or data received from various applications connected to server application 104 and received therein. Reporting database 318 may be implemented in any suitable manner or on any suitable system. Server application 104 may be configured to store information associated with a given patient in the associated PHR in PHR database 256. Furthermore, server application 318 may be configured to store information about actions taken in reporting database 318.

As shown above, server application 104 may be communicatively coupled to any suitable kind, number, or combination of other applications such as caregiver 116, patient 108, EMS 120, or admin 112 applications. Server application 104 may be communicatively coupled to such entities through any suitable mechanism, such as one or more networks 302. Furthermore, each of caregiver 116, patient 108, EMS 120, or admin 112 applications may be communicatively coupled to each other through any suitable mechanism, such as one or more networks 302. Networks 302 may be, for example, wired, wireless, fiber-optic, coaxial cable, 802.11-class, Bluetooth, microwave relay, or any suitable combination thereof.

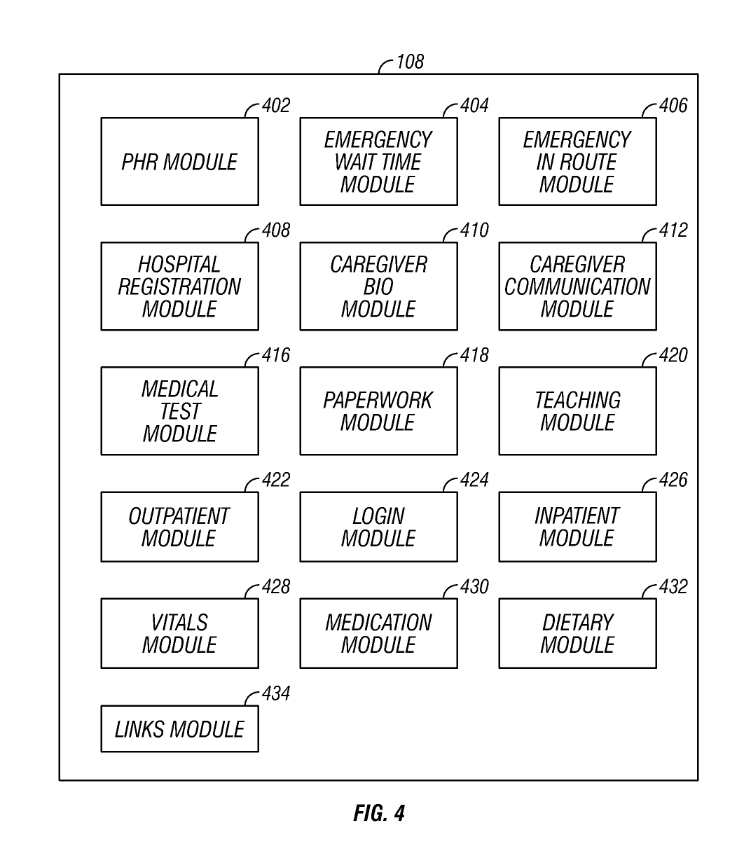

FIG. 4 illustrates an example embodiment of patient application 108. Patient application 108 may include any suitable number of modules, interfaces, and displays to perform the operation as described herein. Each module may be implemented by any suitable combination of code, logic, applications, scripts, functions, executables, firmware, input/output mechanisms, displays, views, software, or hardware. For example, patient application 108 may include a PHR module 402, emergency wait time module 404, emergency en-route module 406, hospital registration module 408, caregiver bio module, caregiver communication module 412, medical test module 416, paperwork module 418, teaching module 420, outpatient module 422, login module 424, inpatient module 426, vitals module 428, medication module 430, dietary module 432, and links module 434. Each such module may be associated with one or more user screens configured to provide input and output to a user of patient application 108. Furthermore, each such module may be configured to cause information to be sent to another portion of system 100, such as to server 102 for distribution to caregiver applications.

PHR module 402 may be configured to illustrate any suitable aspect of a PHR record for the user of patient application 108. Furthermore, PHR module 402 may be configured to issue or authorize a PHR, or a subset thereof, to a third party, such as an EMT, caregiver, or healthcare facility system. PHR module 402 may include information for a user of patient application 108 such as user information, preferences, personality information, medical history, medications and medication allergies, caregiver information, insurance information, legal advance directives, and vital medical information. PHR module 402 may include any suitable mechanism for inputting, editing, or verifying elements of the PHR. Furthermore, PHR module 402 may be configured to selectively send or authorize any subset of such information of the PHR to a designated recipient. Also, PHR module 402 may be configured to selectively seek verification of any subset of such information of the PHR from a user of patient application 108. Such user information may include name, address, identification numbers, contact information for a user of patient application 108, and emergency contacts for a user of patient application 108. PHR module 402 may include an option for pushing, publishing, or sharing the information to other users or elements of system 100. Upon selection of such an option, PHR module 402 may be configured to display any suitable combination of indicators or documents to inform a user of the consequences of such sharing. For example, PHR module 402 may be configured to display a release, warning, disclosure, or other information that must be acknowledged by the user before the information will be shared. PHR module 402 may be used in conjunction with any suitable aspect of patient application 108. The information sent or authorized by PHR module 402 may be sensitive to the context in which it is invoked. For example, check-in to a hospital or an on-may-way message may be accompanied by a PHR with current vital statistics. In another example, outpatient communication may be accompanied with information about medication dosage usage or educational videos that have been watched.

User preferences may include a default designation of preferred healthcare facilities. Such facilities may be given default access to the PHR or may be used in conjunction with emergency wait time module 404 or emergency en-route module 406. User preferences may also include pharmacy information. Furthermore, user preferences may include options to allow caregivers in system 100 to update a PHR, EMS workers in system 100 to access the PHR, or allow healthcare facility registrations to access the PHR. Accordingly, a user of patient application 108 may be given control of the PHR. Furthermore, the user preferences may include options for enabling alerting authorized users of system 100 to view an on-the-way-to-emergency-room status, emergency notes from an emergency room, notes from admission to a healthcare facility, and notes from discharge from a healthcare facility.

Furthermore, PHR module 402 may include communication with other entities in system 100 into a given PHR for a given user of patient application 108.

In addition, PHR module 402 may be configured to allow a user of patient application 108 to forward the PHR to any specified user of system 100, such as a specific caregiver, a facility generally, or a department of a facility. PHR module 402 may be configured to allow a user of patient application 108 to see the information that is to be forwarded before forwarding such information. PHR module 402 may include just-in-time mechanisms to selectively edit, verify, or delete any such part of the PHR before forwarding it. PHR module 402 may present one or more entities, caregivers, or other destinations of a PHR to a user of patient application 108.

Medical history information may include ongoing medical conditions including date of onset, prior medical conditions including relevant dates, surgical history including dates, family medical history, immunization history, vital signs, medications, allergies, and social history including risk factors and drug use.

Caregiver information may include a caregiver identified as a user of system 100. The identification of the caregiver may be selectable from a list of users of system 100. A caregiver may be designated, for example, as a specialist or primary care physician.

Insurance information may include primary or secondary insurance account information. Insurance information may be uploaded to the PHR by use of, for example, a camera on an electronic device upon which patient application 108 is operating.

Legal advance directive information may include do-not-resuscitate information, specific directives to physicians, medical power of attorney, mental health directives, or organ donor information. Each such information may be enabled or disabled. Furthermore, a camera attached to an electronic device upon which patient application 108 is operating may be used to scan or capture such forms. Furthermore, each such piece of information may be individually forwarded or verified.

Emergency wait time module 404 may be configured to determine, for one or more emergency facilities, a wait time for a user of patient application 108. Emergency wait time module 404 may be configured to provide such information for a specified or selected facility of system 100. The information may include wait times for various degrees of severity, such as minor, urgent, and emergency situations. Emergency wait time module 404 may make such determinations by evaluating the workloads, staffing, cases, or other real-time information at the facility. Emergency wait time module 404 may be configured to accept information regarding a severity of a condition from a user of patient application 108. Such a severity may be defined quantitatively or qualitatively. Furthermore, emergency wait time module 404 may be configured to suggest emergency room units, urgent care units, or other medical facilities based upon severity of a condition indicated by a user of patient application 108. In addition, emergency wait time module 404 may be configured to suggest emergency room units, urgent care units, or other medical facilities based upon a location of a user of patient application 108, directing a user to a closest facility. The location of the user may be provided by a GPS sensor on an electronic device operating patient application 108, by inferring location based on wireless communication stations, or by any other suitable method. Based on a user's location, emergency wait time module 404 may be configured to provide directions to a facility to a user. Such directions may be provided through, for example, a map interface. The configuration of emergency wait time module 404 may also be used by, for example, EMS application 120 or registration application 121 to determine wait times, patient loads, routing of patients, or estimated times of arrival.

Furthermore, emergency wait time module 404 may be configured to accept a planned arrival time for a user of patient application 108. Emergency wait time module 404 may accept input regarding a medical emergency condition as well as arrival mode. The planned arrival time may be, for example, accepted through input from a user of patient application 108, or determined through geographic location of the user and the planned mode of transport, such as car or ambulance. The planned arrival time may be updated and sent to system 100 upon, for example, changing traffic conditions detected in relation to the geographic location of the patient.

Emergency en-route module 406 may be configured to provide emergency room, urgent care, or other facility check-in for a user of patient application 108. Such a check-in may be made before a user of patient application 108 leaves for the specified facility. Emergency en-route module 406 may solicit triage information from a user of patient application 108 and provide the information to the facility, along with a PHR of the user. Emergency en-route module 406 may include an interactive display of a human body to provide triage information including selectable symptoms.

Emergency en-route module 406 may also be configured to receive and display push notifications or other messages from a caregiver while the patient is en-route to or has arrived at the facility. Such notifications may include, for example, additional inquiries as to medical history, authorizations, symptoms, or other necessary information.

Furthermore, if a patient is en-route to a facility, as communicated by any suitable mechanism such as emergency en-route module 406 or EMS application 120, the facility may be configured to receive the en-route information from the patient and prioritize the patient. The patient may be placed in a higher priority if arriving by EMS. Also, emergency en-route module 406 may be configured to communicate with system 100 to provide arrival status, check-in status, room assignment, or other information.

In addition, emergency en-route module 406 may include options for a shortcut or one-button option to dialing an emergency help number, such as 9-1-1 or a caregiver at the facility.

Hospital registration module 408 may be configured to provide a series of steps for a user of patient application 108 to check-in to a specified and specific healthcare facility. Such steps may be similar to emergency en-route module 406. Hospital registration module 408 may be configured to prompt a user to review and verify certain portions of the PHR, such as contact information, medical history, medications, and allergies. Furthermore, hospital registration module 408 may prompt a user to fill out, sign, or verify specified forms releases, directives, permissions, authorizations, notices, or other documents. Hospital registration module 408 may be configured to provide the ability to digitally or electronically sign such forms. The forms may be stored and may be printable with such a signature located in the correct position. Hospital registration module 408 may communicate with, for example, an instance or users of registration application 121 to determine forms to be filled out. Some or all of hospital registration module 408 may be accessible or used by other portions of patient application 108 to sign forms as necessary within a variety of contexts, such as transport through EMS, visiting a healthcare facility, paperwork required for medical insurance or outpatient care, or any other suitable circumstance.

Hospital registration module 408 may include any suitable components for providing for a user to sign various forms, releases, directives, permissions, authorizations, notices, or other documents. Hospital registration module 408 may include a signature line, checkboxes, or other mechanism for indicating an acceptance or affirmation. In one embodiment, hospital registration module 408 may include mechanisms configured to provide corroboration to the user's acceptance. For example, a device upon which patient application 108 is executing may be equipped with a still or video camera. If such a camera is front-facing, wherein the camera faces a user using the electronic device, the camera may be activated and capture the action of the user actually electronically signing the form. The resultant image or video clip may be stamped with a date, time, and determined geographic location. The stamped information may be encoded so as to prevent corruption, tampering, or forgery. Furthermore, the input of electronic device may be recorded in real-time, using such techniques such as a screen-capture. A window of hospital registration module 408 may display the process that is being recorded or captured in real-time. The corroborating information may be reviewable by the user or another entity, such as a user of registration application 121, at a later time.

In addition, hospital registration module 408 may prompt a user to verify that the user is visible or recognizable to such a camera during the process of signing. Hospital registration module 408 may determine whether a face is visible or recognizable within the frame of the camera. If a camera of the electronic device upon which patient application 106 is operating is not front facing, then hospital registration module 408 may be configured to prompt a user to take a picture of the user's self immediately before or after signing the forms. The resultant date, time, and location stamp may thus indicate that the user was present at a time and place close to the signing of the forms. Furthermore, signing such forms may trigger hospital registration module 408 to prompt a user to verify log-in information, such as a username and password, QR code, or fingerprint. Such information may further corroborate the signing of the forms.

Caregiver bio module 410 may be configured to display a biographical background of a caregiver assigned to or available to be assigned to a user of patient application 108. The selection of a caregiver may be made by presenting a user of patient application 108 one or more choices of healthcare facilities or participating caregivers of system 100. Given a selected healthcare facility, caregiver bio module may present one or more caregivers to select to a user of patient application 108. In one embodiment, caregiver bio module 410 may by default present options to show a background of caregivers currently assigned within system 100 to a user of patient application 108. The bio background may detail education, specialization, or other information. Caregiver bio module 410 may include a button or other mechanism for contacting an identified caregiver. Such a mechanism may be implemented in conjunction with, for example, caregiver communication module 412. The bio background may be maintained, managed, edited, or otherwise controlled by, for example, an instance of caregiver application 116 or administration application 112.

Caregiver communication module 412 may be configured to facilitate, record, and display communications between a caregiver and a user of patient application 108. Such a caregiver may be a user of system 100 through, for example, caregiver application 116. Caregiver communication module 412 may be configured to be used in conjunction with one or more other modules of patient application 108. For example, caregiver communication module 412 may be used to facilitate or record specific communications with caregivers to give triage information in conjunction with emergency en-route module 406. In another example, caregiver communication module 412 may be used to facilitate specific or record specific communications with caregivers while a patient is admitted to a healthcare facility as used in inpatient module 426, or after discharge in outpatient module 422. Caregiver communication module 412 may be configured to display a series of messages between a user of patient application 108 and a caregiver. Such messages may have been transported using any suitable communications mechanism, such as text messages, instant messages, or other electronic messaging. Information from caregiver communication module 412 may be attached to the PHR. In one embodiment, such information may be selectively included in the PHR in association with particular diagnoses or medical conditions. In one embodiment, outpatient module 422 may include a customizable pill alert. The pill alert may include views, functions, or other mechanisms to enter a medication to be taken, when the medication is to be taken, and an acknowledgement of whether the medication was taken. Furthermore, outpatient module 422 may be configured to report or log usage data, or to receive updates from or synchronize with another portion of system 100.

Caregiver communication module 412 may present a templatized mechanism for a user of patient application 108 to input communication to a caregiver. Such a templatized approach may be used to standardize, simplify, and focus communication from a user of patient application 108 to a caregiver. The templatized mechanism may include a hierarchy of possible communications that can be built upon each other. In one embodiment, various aspects of the templatized mechanisms may be implemented with pictures, graphics, pictograms, or other graphical presentation. In another embodiment, various aspects of the templatized mechanisms may be configured to be presented and translated into various foreign languages according to the preferences of patient application 108.

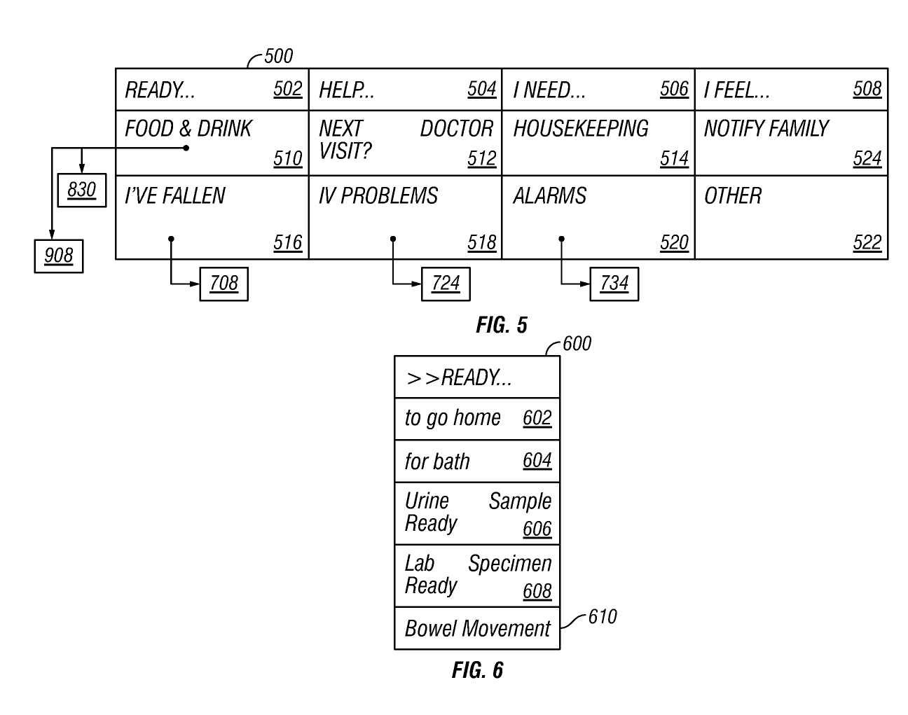

FIG. 5 illustrates an example templatized communication view 500 that may implement communication in, for example, caregiver communication module 412. View 500 may be implemented by, for example, displays, menus, software modules, input-output mechanisms such as sliders, buttons, voice-clip capture, cameras, pictograms, graphics, images, and textboxes. View 500 may include a hierarchy of possible actions that may be taken by a user of patient application 108. The contents of view 500 may be configured according to a healthcare situation of the patient. In the example of FIG. 5, view 500 may be substantially shown as for a patient in a hospital, emergency room, nursing facility, or doctor's office.

In one embodiment, each level of the hierarchy may add an element of a desired communication for a user of patient application 108. For example, view 500 may include an option 502 for a user to declare that the user is ready for some action, task, or activity. View 500 may include an option 504 for a user to declare that the user needs assistance with something. Furthermore, view 500 may include an option 506 for a user to declare that the user needs something. In addition, view 500 may include an option 508 for a user to report a feeling, symptom, or other medical condition.

In another embodiment, view 500 may present shortcuts at a top-level of such a hierarchy to simply important or critical communications for a user of patient application 108. In one further embodiment, some such shortcuts may be shortcuts to other portions of the hierarchy that may have been accessible through drilling down of other options. For example, view 500 may include an option 510 for a user to declare that the user needs something to eat or drink. Option 510 may correspond to, for example, options 830 or 908, discussed below. View 500 may include an option 516 for a user to declare that the user has fallen. Option 516 may correspond to, for example, option 724, discussed below. View 500 may include an option 518 for a user to declare that a problem exists with an intravenous device (IV). Option 518 may correspond to, for example, option 724, discussed below. View 500 may include an option 520 for a user to declare that one or more alarms are going off. Option 520 may correspond to, for example, option 734, discussed below. In another, further embodiment, some such shortcuts may represent terminal options without sub-choices that reside within view 500. For example, view 500 may include an option 512 for a user to ask when the next time a doctor will visit. Furthermore, view 500 may include an option for a user to ask for housekeeping for a hospital room.

View 500 may include an option 524 for notifying other parties, such as family or friends. A high-level summary of the patient's condition may be sent to the specified recipient, along with an indication of the patient's room number. In one embodiment, option 524 may provide other options for specifying a phone number, e-mail, or other destination for a summary or report. In another embodiment, option 524 may determine recipient information from a PHR field designating, for example, next of kin or emergency contacts.

View 500 may include options 522 for other activities that may be grouped or presented in any suitable manner.

As described above, elements within the hierarchy of options of view 500 may correspond to other elements within the hierarchy of options of view 500. Ease-of-use may be increased by providing multiple avenues of reaching a desired action for a user of patient application 108. Any suitable cross-referencing of options may be performed within view 500 or its associated hierarchy.

View 500 may implement a variable presentation of options, including submenus or shortcuts. The variable configuration of 500 may be based upon, for example, a healthcare facility to which a patient is admitted or particular medical conditions of the patient. For example, option 518 may present a shortcut for IV problems if a patient is using an IV device. However, option 518 may be replaced if the patient is not using an IV, or may be shown in addition to a similar option for another device in use by the patient, such as a heart monitor. In another example, wherein a user has a frequent bowel problem and needs assistance getting out of bed, view 500 may be configured to include shortcut on the front display for assistance getting out of bed, wherein such an option is otherwise embedded within the hierarchy of options. Furthermore, the variable configuration of view 500 may based upon the entity that initiated a conversation. For example, a query initiated by a patient user of patient application 108 may include a full range of possible options to report a condition. In another example, a query initiated by a caregiver user of caregiver application 116 to a patient using patient application 108 to inquire about a specific symptom or experience may be shown in view 500 with options associated with the specific inquiry made by the caregiver.

Any one of the options presented in view 500 or in its hierarchy of options may be represented by text alone, a pictogram, an icon, a drawing, or any combination thereof. For example, option 510 may include a pictogram of a plate, knife, and fork, or of a glass or cup. Option 516 may include a pictogram or a person on a floor next to a bed. Option 520 may include an image of a red light flashing. Option 518 may include a picture of an IV device. Option 514 may include a pictogram of a broom or of a trash can being emptied.

When selected, options within view 500 or its hierarchy may be routed to an appropriate caregiver. Such a routing and delivery may be made through caregiver application 116. Messages or information generated by some options may be directed to a specific caregiver identified by a user of patient application 108. The appropriate routing of other messages may be determined by server application 104. Such routing may be determined by, for example, on-duty or on-call status of caregivers, the nature of the question, the assignment of a patient to one or more caregivers, or the initiator of the conversation. For example, options such as option 516 indicating that a patient has fallen need to be sent to the nearest caregiver. Server application 104 may route the message to on-duty or on-call nurses on the same floor, wing, or other part of a facility as the patient. A nurse may be selected over, for example, a specialist, because a nurse may be the most appropriate class of caregiver to handle the communication. Furthermore, any accessible on-call or on-duty nurses may be selected, as opposed to only specific nurses assigned to the patient, because handling such an issue requires no personalized handling. In contrast, selected options such as those requesting pain medications may be handled by pain-specialist nurses or doctors specifically assigned to the patient, as dispensation of such medication may require consideration of a greater range of larger issues and information. Furthermore, the dispensation may require accountability for the decision-making underlying such a medical decision.

Information communicated with a selection of an option from view 500 or its hierarchy may include selective information about the patient. The information may include the patient's name, age, gender, and location (such as room number). Furthermore, depending upon the context of the reported information, real-time medical data, portions of the patients PHR, or other information may be selectively harvested and sent to a caregiver. Upon receipt, a user of caregiver application 116 may have one-button or other expedited access the received information such as the PHR, radiology reports, laboratory reports, EMR notes, or current medications list.

For example, if a patient selects an option declaring that the user feels feverish, a history of temperature readings from the previous twenty-four hours may be delivered to the caregiver along with the alert originating from the original selection. In another example, if a patient selects an option declaring that the patient feels like they have low blood sugar, the patient's insulin regiment from the patient's PHR may be reported to the caregiver. Such information may be presented in-line with the alert or may be highlighted in a PHR view to the caregiver in caregiver application 116. In yet another example, a patient's dietary or water restrictions from a PHR may be presented simultaneously with a patient's electronic request for food, water, or ice.

Selection of options in view 500 and in its hierarchy may be stored to a PHR along with a timestamp.

For a given communication between a patient and a caregiver, or between two caregivers, an indication may be made to illustrate whether the message has been delivered and read. Such a “read” condition may include a determination of whether a conversation view including the message has been presented to the recipient.

Although specific examples of options in view 500 and in its hierarchy are presented herein, variations may be made in the selection and presentation of such options without varying from the spirit of embodiments of the present disclosure.

FIG. 6 illustrates an example embodiment of a view 600 including options for a user to indicate readiness. View 600 may illustrate further operations derived from selection of option 502 from view 500. In particular, view 600 may illustrate further options for a user to declare that the user is ready for an action, task, service, or other event.

For example, view 600 may include an option 602 for a user to declare that the user is ready to check out of the facility to return home. Option 602 may include a pictogram of a house. Selection of option 602 may be routed to an on-duty nurse or other caregiver or to hospital admitting staff using an instance of caregiver application 116 or admin application 112.

View 600 may include an option 604 for a user to declare that the user is ready for a bath or shower. Option 604 may include a pictogram of a showerhead and a person. Selection of option 604 may be routed to, for example, a nurse's aid or on-duty nurse or other caregiver using an instance of caregiver application 116.

View 600 may include an option 606 for a user to declare that a requested specimen, such as a stool or urine sample, is ready for pickup. Such a specimen may be available, for example, within the room of the patient. Selection of option 606 may be routed to, for example, a lab technician, doctor assigned to the patient, or nurse assigned to the patient using an instance of caregiver application 116. The information may include a room number of the patient.

View 600 may include an option 608 for a user to declare the patient is ready to give a lab specimen, such as blood. Selection of option 606 may be routed to, for example, a lab technician, doctor assigned to the patient, or nurse assigned to the patient using an instance of caregiver application 116.

View 600 may include an option 608 for a user to declare that the patient is ready to use the restroom. Option 608 may include a pictogram of a toilet, for example. Selection of option 608 may be routed to, for example, a nurse's aid or on-duty nurse or other caregiver using an instance of caregiver application 116.

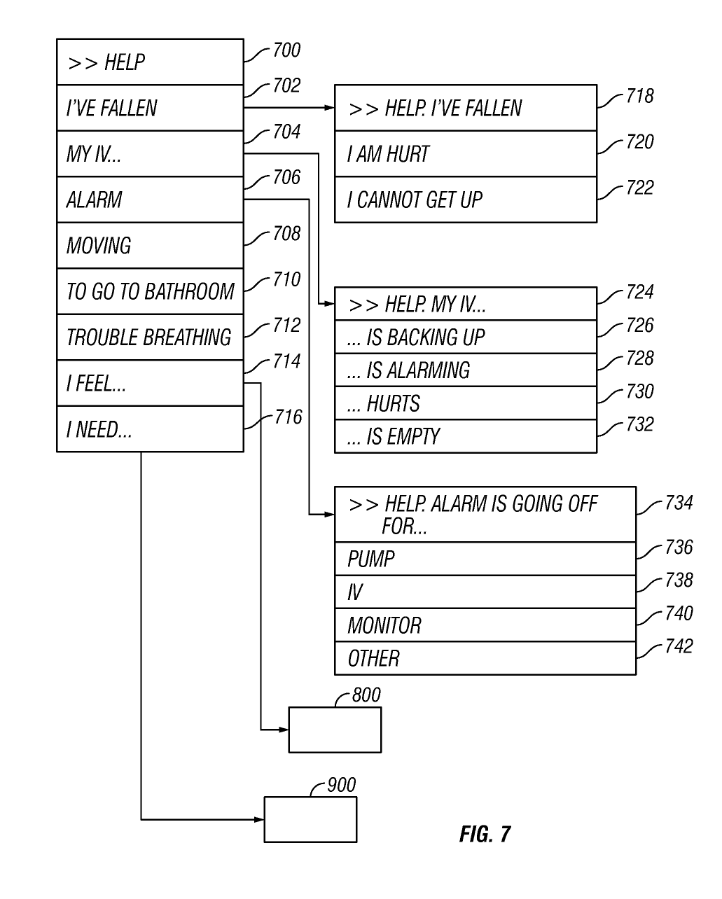

FIG. 7 illustrates an example embodiment of a view 700 including options for a patient to enter regarding assistance. View 700 may illustrate further operations derived from selection of option 504 from view 500. In particular, view 700 may illustrate further options for a user to declare that the user needs help in some fashion.

For example, view 700 may include an option 702 for a user to declare that the user has fallen. Option 702 may include, for example, a pictogram of a person on the ground next to a bed. Selection of option 702 may be routed to an on-duty nurse or other caregiver using an instance of caregiver application 116. Furthermore, selection of option 702 may cause additional options to be displayed, such as those within view 718. View 718 may summarize the selections made thus far, such as an indication that help is needed and that the patient has fallen. View 718 may include an option 720 for a user to declare that the user is also hurt. Option 720 may include, for example, a pictogram of a bandage, or of pain radiating from an appendage of a person. View 718 may include an option 722 for a user to declare that the user cannot stand up. Selection of one of options 720, 722 may be handled by patient application 108 by concatenating, evaluating, or logically combining the selections to form a single message to a caregiver through an instance of caregiver application 116. Furthermore, if one of options 720, 722 is not selected within a given time period, patient application 108 may send a message with base information—such as that help is needed because the patient has fallen.

View 700 may include an option 704 for a user to declare that the user needs help with a particular medical device, such as an IV. The display and operation of option 704 may be conformed to the type of medical device in use. For example, option 704 may include a pictogram of an IV and may generate a list of possible problems specific to IVs. Selection of option 704 or any of its subsequent options may be routed to an on-duty nurse or other caregiver using an instance of caregiver application 116. Selection of option 704 may cause additional options to be displayed, such as those within view 724. View 724 may summarize the selections made thus far. View 724 may include an option 726 for a user to declare that the IV is backing up and not dripping. Option 726 may include, for example, a pictogram of an IV with an “x” on the tube from the IV to a person. View 724 may include an option 728 for a user to declare that the IV is generating an alarm. Option 728 may include, for example, a picture of a red light flashing. View 724 may include an option 730 for a user to declare that the IV is hurting the patient. Option 730 may include, for example, a pictogram showing pain radiating from an appendage of a person. View 724 may include an option 732 for a user to declare that the IV is empty or has completed. Option 732 may include, for example, a pictogram of an IV with no contents or an image of fuel gauge on ‘E’. Selection of one of such options may be handled by patient application 108 by concatenating, evaluating, or logically combining the selections to form a single message to a caregiver through an instance of caregiver application 116. Furthermore, if one of such options is not selected within a given time period, patient application 108 may send a message with base information—such as that help is needed because of an IV.

View 700 may include an option 706 for a user to declare that help is needed because an alarm is going off. Option 706 may include, for example, an image of a flashing red light. Selection of option 706 or any of its subsequent options may be routed to an on-duty nurse or other caregiver using an instance of caregiver application 116. Selection of option 706 may cause additional options to be displayed, such as those within view 734. View 734 may summarize the selections made thus far. View 734 may include an option 736 for a user to declare that an alarm is going off for a pump. Option 736 may include, for example, a pictogram of a pump. View 734 may include an option 738 for a user to declare that the IV is generating an alarm. Option 738 may include, for example, a pictogram of an IV. View 734 may include an option 740 for a user to declare that a monitor is generating an alarm. Option 740 may include, for example, a pictogram of the monitor. View 734 may include an option 742 for a user to declare that another device is generating the alarm. Selection of one of such options may be handled by patient application 108 by concatenating, evaluating, or logically combining the selections to form a single message to a caregiver through an instance of caregiver application 116. Furthermore, if one of such options is not selected within a given time period, patient application 108 may send a message with base information—such as that help is needed because of an alarm.

View 700 may include an option 708 for a user to declare that the user needs help moving. Option 708 may include, for example, a pictogram of a person attempting to sit up in a bed. Selection of option 708 may be routed to a nurse's assistant, on-duty nurse, or other caregiver using an instance of caregiver application 116.

View 700 may include an option 710 for a user to declare that the user needs help going to the restroom. Option 710 may include, for example, a pictogram of a toilet. Selection of option 710 may be routed to a nurse's assistant, on-duty nurse, or other caregiver using an instance of caregiver application 116. Selection of option 710 may yield a similar communication as, for example, option 610.

View 700 may include an option 712 for a user to declare that the user has trouble breathing. Option 712 may include, for example, a pictogram of an oxygen mask. Selection of option 712 may be routed to an on-duty nurse, doctor, or other caregiver using an instance of caregiver application 116.

View 700 may include an option 714 for a user to declare that the user needs help because the user is feeling a certain way or experiencing a specific condition. Option 714 may yield a similar or same sequence of operation as selection of option 508 and may be handled as shown by view 800, discussed below.

View 700 may include an option 716 for a user to declare that the user needs help because the user needs something. Option 716 may yield a similar or same sequence of operation as selection of option 506 and may be handled as shown by view 900, discussed below.

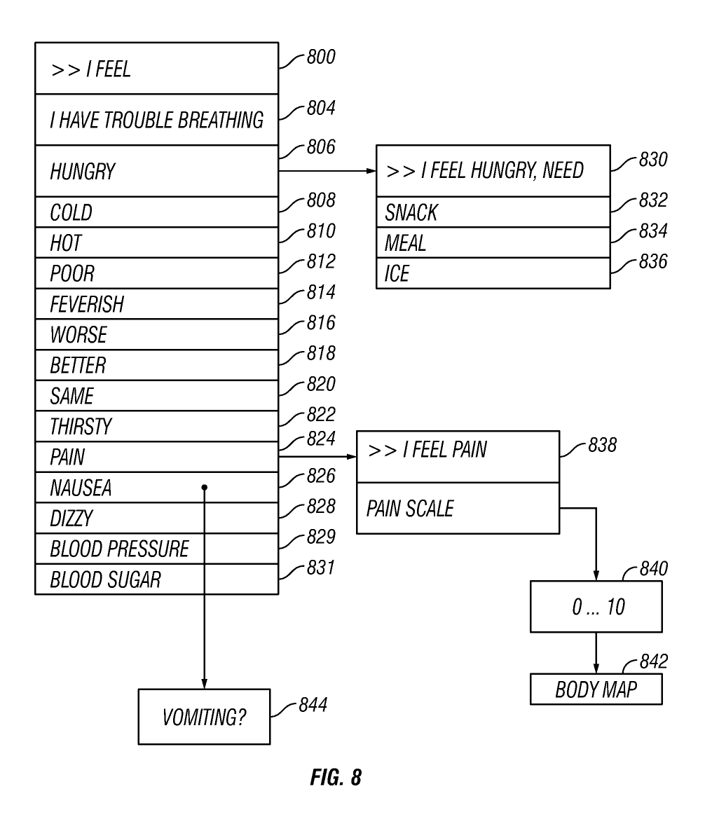

FIG. 8 illustrates an example embodiment of a view 800 including options for a user to indicate symptoms. View 800 may illustrate further operations derived from selection of option 508 from view 500. In one embodiment, view 800 may illustrate operations derived from selection of option 714 from view 700. In particular, view 800 may illustrate further options for a user to declare that the user is experiencing a particular feeling, condition, or symptom. Selection of an option within view 800 may be handled by patient application 108 by concatenating, evaluating, or logically combining the selections to form a single message to a caregiver through an instance of caregiver application 116. Furthermore, if an option is not selected within a given time period, patient application 108 may send a message with base information representing selections made thus far. Each element or option of view 800 may include a subsequent option for a user to indicate a severity level. Such levels may be made, for example, with a numeric range (such as one to ten), a qualitative range (such as less, much less, more, much more), or pictograms, pictures, or other images.

For example, view 800 may include an option 802 for a user to declare that the user is having trouble breathing. Option 802 may include, for example, a pictogram of an oxygen mask. Selection of option 802 may be routed to an on-duty nurse, doctor, or other caregiver using an instance of caregiver application 116. Option 802 may generate similar communication as option 712.

View 800 may include an option 804 for a user to declare that the user is hungry. Option 804 may include, for example, a pictogram of a plate and utensils. Selection of option 804 may be routed to an on-duty nurse, nurse's aid, or other caregiver using an instance of caregiver application 116. Option 804 may implement or may generate similar communication as option 510. Selection of option 804 may cause additional options to be displayed, such as those within view 830. View 830 may summarize the selections made thus far, such as an indication that the patient is hungry. View 830 may include an option 832 for the user to communicate that the user wants a snack or is slightly hungry. Option 832 may include, for example, a pictogram of a small amount of food, candy, crackers, or other suitable image. Furthermore, view 830 may include an option 834 for a user to declare that the user is ready for a meal. Option 834 may include, for example, a pictogram of a plate of food. View 830 may include an option 836 that the user wants ice. Option 836 may include, for example, a pictogram of a glass of ice.

View 800 may include an option 808 for a user to declare that the user is cold. Option 808 may include, for example, a pictogram of a thermometer that is blue or has a low reading. Selection of option 808 may be routed to an on-duty nurse, nurse's aid, or other caregiver using an instance of caregiver application 116.

View 800 may include an option 810 for a user to declare that the user is hot. Option 810 may include, for example, a pictogram of thermometer that is red or has a high reading. Selection of option 810 may be routed to an on-duty nurse, nurse's aid, or other caregiver using an instance of caregiver application 116.

View 800 may include an option 812 for a user to declare that the user feels poorly or badly. Selection of option 808 may be routed to an on-duty nurse, nurse's aid, or other caregiver using an instance of caregiver application 116.

View 800 may include an option 814 for a user to declare that the user is feeling feverish. Option 814 may include, for example, a pictogram of thermometer that is red or has a high reading. Selection of option 814 may be routed to an on-duty nurse, doctor, or other caregiver using an instance of caregiver application 116.

View 800 may include an option 816 for a user to declare that the user is feeling worse, an option 818 for a user to declare that the user is feeling better, or an option 820 for a user to declare that the user is feeling the same. Selection of one of these options may be routed to an on-duty nurse, doctor, or other caregiver using an instance of caregiver application 116.

View 800 may include an option 822 for a user to declare that the user is thirsty. In one embodiment, selection option 822 may be handled according to the selection of option 908, described below. Option 822 may include, for example, a pictogram of glass of water or a glass of ice. Selection of option 822 may be routed to an on-duty nurse, nurse's aid, or other caregiver using an instance of caregiver application 116.

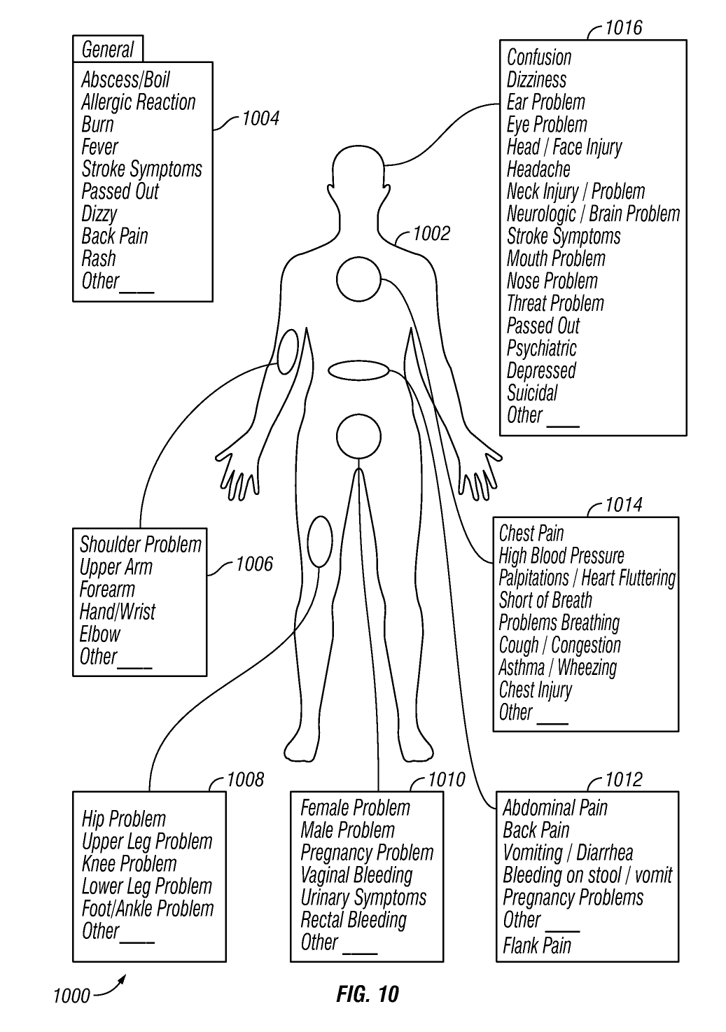

View 800 may include an option 824 for a user to declare that the user is feeling pain. Option 822 may include, for example, a pictogram of pain radiating from an appendage of a person. Selection of option 822 may be routed to an on-duty nurse, on-duty doctor, assigned doctor, or other caregiver using an instance of caregiver application 116. Selection of option 824 may cause additional options to be displayed, such as those within view 838. View 838 may summarize the selections made thus far, such as an indication that the patient is in pain. View 838 may include an option 840 for the user to communicate a level of pain that the user is experiencing. Option 840 may include, for example, a sliding scale from one to ten. Furthermore, selection of a pain scale in option 840 or pain in general in option 824 may cause a body map option 842. Body map option 842 may be configured to display any suitable image or map of a person's body for the patient to input where the pain is located. Such a body map option 842 may be shown in greater detail in conjunction with FIG. 10, below.

View 800 may include an option 826 for a user to declare that the user is experiencing nausea. Selection of option 822 may be routed to an on-duty nurse, on-duty doctor, assigned doctor, or other caregiver using an instance of caregiver application 116. Selection of option 822 may cause a further option 844 to prompt the user to indicate whether vomiting has occurred. Furthermore, selection of option 822 may cause prompting for a user to indicate a severity of nausea.

View 800 may include an option 828 for a user to declare that the user is experiencing dizziness. Option 828 may include, for example, a pictogram of a person's head with one or more criss-crossing rings around the person's head. Selection of option 828 may be routed to an on-duty nurse, on-duty doctor, assigned doctor, or other caregiver using an instance of caregiver application 116. Furthermore, selection of option 828 may cause prompting for a user to indicate a severity of dizziness.

View 800 may include an option 829 for a user to declare that the user is experiencing blood pressure problems. Option 829 may include, for example, a scale for blood pressure indicating that the blood pressure is too high or too low. Selection of option 829 may be routed to an on-duty nurse, doctor, or other caregiver using an instance of caregiver application 116.

View 800 may include an option 831 for a user to declare that the user is experiencing blood sugar problems. Option 831 may include, for example, a scale for blood sugar indicating that the blood pressure is too high or too low. Selection of option 831 may be routed to an on-duty nurse, doctor, or other caregiver using an instance of caregiver application 116.

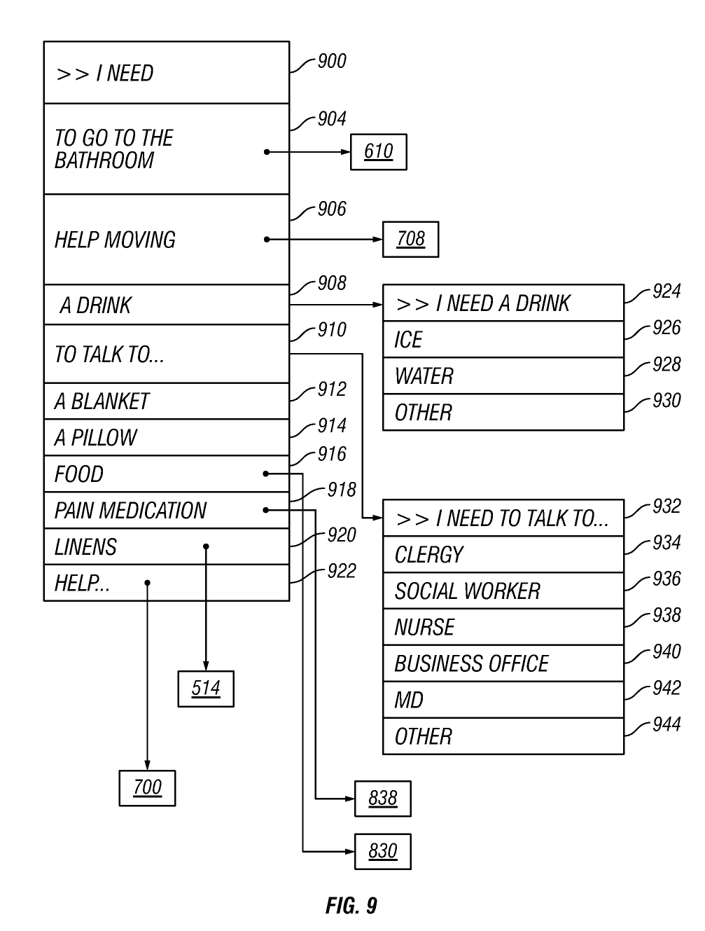

FIG. 9 illustrates an example embodiment of a view 900 including options for a user to indicate needs. View 900 may illustrate further operations derived from selection of option 506 from view 500. In one embodiment, view 900 may illustrate operations derived from selection of option 716 from view 700. In particular, view 900 may illustrate further options for a user to declare that the user needs something. Selection of an option within view 900 may be handled by patient application 108 by concatenating, evaluating, or logically combining the selections to form a single message to a caregiver through an instance of caregiver application 116. Furthermore, if an option is not selected within a given time period, patient application 108 may send a message with base information representing selections made thus far.

For example, view 900 may include an option 904 for a user to declare that the user needs to go to the restroom. Option 904 may be implemented in similar fashion in configuration, appearance, and operation as option 610.

View 900 may include an option 906 for a user to declare that the user needs help moving. Option 906 may be implemented in similar fashion in configuration, appearance, and operation as option 708.

View 900 may include an option 908 for a user to declare that the user needs a drink. Option 908 may include, for example, a pictogram of a glass of liquid. Selection of option 908 may be routed to an on-duty nurse, nurse's aid, or other caregiver using an instance of caregiver application 116. Selection of option 908 may cause additional options to be displayed, such as those within view 924. View 924 may summarize the selections made thus far, such as an indication that the patient needs a drink. View 924 may include an option 926 for the user to request ice (which may be represented by a pictogram of a glass of ice); an option 928 for the user to request water (which may be represented by a pictogram of a glass of water); or an option 930 for the user to request another kind of drink, such as coffee (which may be represented by a pictogram of a coffee cup.

View 900 may include an option 910 for a user to declare that the user needs to talk to someone. Option 910 may include, for example, a pictogram of a person speaking Selection of option 910 may be routed to an on-duty or assigned nurse, doctor, or other caregiver using an instance of caregiver application 116, or an administrator using an instance of admin application 112. Selection of option 908 may cause additional options to be displayed, such as those within view 932. View 932 may summarize the selections made thus far, such as an indication that the patient needs to talk to someone. View 932 may include an option 934 for a user to request to speak with a clergy member. A designated, on-duty, or on-call clergy member matched from the user's PHR profile may be selected and contacted. Option 934 may include, for example, a pictogram of clergy symbols or symbols of different religious faiths. View 932 may include an option 936 for a user to request to speak with a social worker or case worker. Such designated, on-duty, or on-call person matched from the user's PHR profile may be selected and contacted. View 932 may include an option 938 for a user to request to speak with a nurse. An on-call or on-duty nurse may be messaged. View 932 may include an option 940 for a user to request to speak with a business office or hospital administrator. An appropriate person may be messaged. Furthermore, view 932 may include an option 940 for a user to request to speak with someone else. Options may be presented for entering a person so-desired, such as a drop-down list or a free text box.

View 900 may include an option 912 for a user to declare that the user needs a blanket. Furthermore, view 900 may include an option 914 for a user to declare that the user needs a pillow. These options may include, for example, a pictogram of the requested object. Selection of these options may be routed to an on-duty nurse, nurse's aid, or other caregiver using an instance of caregiver application 116.

View 900 may include an option 918 for a user to declare that the user needs pain medication. Option 918 may be implemented in similar fashion in configuration, appearance, and operation as option 838.

View 900 may include an option 920 for a user to declare that the user needs linens. Option 906 may be implemented in similar fashion in configuration, appearance, and operation as option 514.

View 900 may include an option 922 for a user to declare that the user needs help, generally. Option 922 may be implemented in similar fashion in configuration, appearance, and operation as view 700.

FIG. 10 illustrates a body map 1000 configured to provide a patient the ability to indicate where symptoms, such as pain, are appearing. Body map 1000 may be configured to be used in conjunction with any suitable portion of system 100, such as with patient application 108 for communicating to a caregiver while in the hospital, for a patient to provide pre-triage information when en-route to a medical facility using patient application 108, or in conjunction with EMS application 120 to provide information en-route to a medical facility.

Body map 1000 may be selectable and interactive, such that selection of a portion of the body in body map 1000 may yield a list of one or more possible specific problems or pain locations. Each such list may be templatized, selectable, contain follow-on options or questions, or contain free-text forms. For example, option 1004 may provide a list of general malaises, problems, or symptoms. Option 1006 may provide possible symptoms associated with arms, shoulders, and hands. Option 1008 may provide possible symptoms associated with hips, legs, or feet. Option 1010 may provide possible symptoms associated with genitalia, reproductive systems, or excretory systems. Option 1012 may provide possible symptoms associated with the back or intestinal, digestive, or lower-torso systems. Option 1014 may provide possible symptoms associated with chest, heart, or lung systems. Option 1016 may provide possible symptoms associated with the head, brain, neck, eyes, ears, or throat, or mental conditions.

Returning to FIG. 4, in one embodiment, caregiver communication module 412 may determine to which caregivers of system 100 that inputted information will be sent. For example, a user of patient application 108 may designated a specific caregiver or no specific caregiver. However, a specified caregiver may be unavailable. Therefore, caregiver communication module 412 may present inputted information in conjunction with a selectively edited portion of the PHR to a caregiver who is, for example, on-call to receive such communication.

Caregiver communication module 412 may be implemented in conjunction with other modules, such as teaching module 420, outpatient module 422, and inpatient module 426. For example, a user of patient application 108 may utilize caregiver communication module 412 while performing healthcare related activities using these modules. The appearance of displays used with caregiver communication module 412 may be selectively adapted according to an inpatient, outpatient, or teaching use. For example, during inpatient or outpatient use, displays used with caregiver communication module 412 may use logos, pictograms, or other images for a patient to communicate with a caregiver. In another example, during teaching mode, displays may include feedback or communication concerning content that is to be viewed.

Medical test module 416 may be configured to provide information about medical tests that have been ordered, conducted, or analyzed for a user of patient application 108. Individual ones of such tests may be selected in patient application 108 for presentation, visualization, or educational information regarding the test. Medical test module 416 may be configured to determine such information from a PHR, for example. In one embodiment, medical test module 416 may be configured to only selectively display medical test information that has been authorized for release by a caregiver. For example, a doctor may have ordered tests but may wish to personally inform a user of patient application 108 about such tests, rather than have a user of patient application 108 learn about the tests for the first time by accessing medical test module 416. In another example, test results may have been received but may not have been analyzed. In yet another example, test results may have been received but a doctor may wish to personally inform a user of patient application 108 about such results.

Furthermore, medical test module 416 may be configured to present results from tests in a fashion organized by recent tests, such as tests within a previous day, week, or month period, with options to expand to views of tests within previous ranges. Medical test module 416 may be configured to index tests by a name of a test and provide options for finding out general information about the kind of test conducted, seeing the specific results, and selectively forwarding them to another user of system 100.

Paperwork module 418 may be configured to present and allowing modification of various forms for a user of patient application 108. Paperwork module 418 may be configured to, for example, provide facility-specific or other document templates, allow insertion of information, allow pictures or files to be submitted. Paperwork managed by paperwork module 418 may include, for example, photographs taken by a user of patient application 108, general documents uploaded by a user of patient application 108, legal forms, lab tests, admission notes, discharge summaries, consultation notes, operation notes, and notes from specialists organized by field. Paperwork module 418 may be configured to allow each such paperwork element to be viewed or selectively forwarded to another user of system 100.

Teaching module 420 may be configured to present educational, medical information to a user of patient application 108. Such information may be determined by a caregiver of a user of patient application 108. For example, a caregiver of a user of patient application 108 may direct the patient to view certain videos, read certain information, or listen to certain audio transmissions. Teaching module 420 may track whether a user of patient application 108 has reviewed such information and answered certain follow-up questions, quizzes, or other mechanisms for affirming understanding. Teaching module 420 may inform a caregiver if a user of patient application 108 has not viewed required information in a specified time frame. Previously viewed content may be designated as such and be available for perusal at a later time.

Outpatient module 422 may be configured to selectively present information and communication for a user of patient application 108 to conduct healthcare-related tasks after discharge from a healthcare facility. Outpatient module 422 may be implemented in conjunction with, for example, caregiver communication module 412. A caregiver may communicate instructions, information, or questions to a user of patient application 108 after a procedure, stay at a healthcare facility, or a visit to a healthcare facility. Such communication may be transmitted using secured electronic communication such as text, instant message, or a proprietary format. Such communication may be handled and presented by outpatient module 422. Outpatient module 422 may display communication between a user of patient application 108 and a caregiver in a chat format, wherein a history of the dialogue may be presented. Furthermore, outpatient module 422 may present such communication on a caregiver-by-caregiver basis, facility-by-facility basis, or a suitable combination of the two. Outpatient module 422 may include an interface for a user of patient application 108 to enter communication as presented by interface 508. Furthermore, outpatient module 422 may include options to call a caregiver assigned to or on-call for an outpatient incident. In addition, outpatient module 422 may include options to record or listen to voice clips, or to take pictures with an electronic device upon which patient application 108 is operating.

Some messages may be sent to patient automatically using outpatient module 422 after discharge from a facility. Such messages may include inquiries from caregivers regarding patient condition. Inquiries to be sent as well as responses may be routed to on-call or on-duty personnel to facilitate response in timely fashion. Messages may be formulated using templates to build sentences to describe current symptoms, conditions, replies, and ordering of prescriptions.

Login module 424 may be configured to log a user of patient application 108 into patient application 108 or to system 100. In one embodiment, login module 424 may include mechanisms for logging in with a username and password. In another embodiment, login module 424 may include scanning mechanisms to scan a user's credentials to verify information and log in to system 100. For example, a user of patient application 108 may have a card, bracelet, or other mechanism with a QR code, barcode, RFID chip, fingerprint, facial recognition, or other information source. An electronic device upon which patient application 108 is operating may include a scanner, camera, reader, or other mechanism for reading the information source. Login module 424 may be configured to create accounts or retrieve lost passwords.

Inpatient module 426 may be configured to selectively present interfaces to a user of patient application 108 based upon such a user's stay in a healthcare facility. The selectively presented interface may include communication options that are specific to, for example, a skilled nursing patient, a patient staying in a hospital or a patient recovering from outpatient surgery in a facility. Inpatient module 426 may be implemented with a selective set of communication as illustrated in caregiver communication module 412 and features associated with outpatient module 422. Vitals module 428 may be configured to provide one or more vital medical statistical data points of a user of patient application 108. Such information may be included in a PHR or otherwise provided to a caregiver user of system 100 when such information is pushed, for example, as part of an en-route operation in association with emergency en-route module 406. Information for vitals module 428 may be input by a user of patient application 108, a device used by a user of patient application 108, or any other suitable manner. Vitals module 428 may be configured to generate graphs or historical vital sign data to send to a caregiver or other party track progress. Furthermore, vitals module 428 may be configured to provide vitals alerts to a user, which may indicate that a user is to take specific vitals at specific time of day to track progress. After input of values, vitals module 428 may be configured to alert a user or automatically send a message to a caregiver if the vitals appear outside of acceptable ranges. Medication module 430 may include a record, reminder, or other indication of medicines to be taken by a user of patient application 108. Based upon medications prescribed by one or more caregivers of system 100, medication module 430 may be configured to remind a user of patient application 108 to take medications.

Dietary module 432 may include an indication of menu options that may be available for a user of patient application 108 to select while in a healthcare facility such as a hospital. Dietary module 432 may be configured to selectively present a subset of menu choices available from the facility. To make such a selective presentation, dietary module 432 may be configured to access medical information from the patient's PHR to determine dietary restrictions and requirements, such as sodium, fat, carbohydrate, calories, special-needs, or allergies. Furthermore, dietary module 432 may be configured to determine the dietary content of various menu options available at the facility. Dietary module 432 may be configured to cross-reference the patient's dietary restrictions and requirements with available menu choices. Based on such a cross-reference, dietary module 432 may be configured to selectively display available menu choices to the patient that match the dietary restrictions and requirements. Menu choices violating the dietary restrictions and requirements, alone or in combination with other selected menu items, may be hidden. Furthermore, menu choices required by dietary restrictions and requirements may be included in a selection by default. A user of patient application 108 may select the menu choices presented in dietary module 432, which may communicate an order to a portion of system 100 configured to alert the preparation of the menu selection and route the selection for delivery to the patient's location.

Links module 434 may be configured to determine one or more network destinations, web sites, or applications available for more information or additional functionality for a user of patient application 108. Links module 434 may be configured to present such information to a user of patient application 108 within any suitable context of patient application 108.

Furthermore, outpatient module 422 may include an option to select to talk to a caregiver face-to-face regarding follow-up information, medication, vitals, or other medical information. Such an option may be configured to set a preference that the user prefers face-to-face communication. The option may also be configured to notify the user that such communication may not be as timely as other communication, such as messaging.

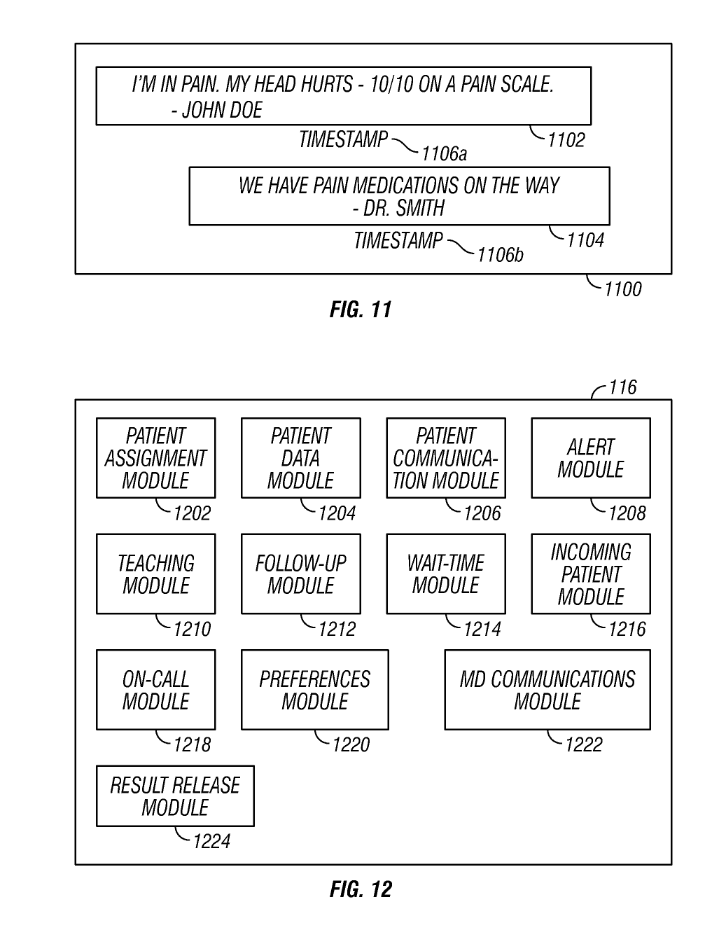

FIG. 11 illustrates an example embodiment of a conversation view 1100. Conversation view 1100 may illustrate the result of entering communication between an instance of patient application 108 and an instance of caregiver application 116. Conversation view 1100 may be implemented in any suitable way, such as by a display illustrating different elements of communication from each party. Conversation view 1100 may be implemented in any suitable portion of, for example, patient application 108, EMS application 120, or caregiver application 116. Conversation view 1100 may display secured messages that have been sent between different users of system 100.

In the example of FIG. 11, a communication 1102 may be constructed by, for example, a patient entering various templatized values or free text in patient application 108 as described above. Furthermore, communication 1102 may include a timestamp 1106a. In response to communication 1102, another communication 1104 may have been constructed and sent by a caregiver using caregiver application 116. Communication 1104 may also include a timestamp 1106b. Communication 1104 may be positioned in relation to communication 1102 to indicate that communication 1104 has occurred at a later time.

The contents of conversation view 1100 may be stored by system 100. The storage of conversation view 1100 may be stored according to the patient associated with the contents of conversation view 1100. In one embodiment, the contents of conversation view 1100 may be between a patient and one or more caregivers. In another embodiment, the contents of conversation view 1100 may be between two or more caregivers. In such an embodiment, even though the patient is not a party to the conversation, the contents of conversation view 1100 may be stored in association with the patient. Thus, contents of conversation view 1100 may be accessible through access of the patient's PHR.

Consequently, multiple instances of conversation view 1100 may exist simultaneously on different applications, such as caregiver application 116 or patient application 108. Such multiple instances may relate to the same patient. A caregiver or a patient may be presented with a choice of such instances of conversation view 1100 from which to choose, or may be presented with the choice of initiating a new instance of conversation view 1100.

Furthermore, in a given instance of conversation view 1100, an option may be presented to terminate or close out a conversation. Such an option may be implemented by, for example, a separate, explicit option or by an option for a response that inherently terminates the conversation. For example, an option for a response by a caregiver that a requested medication is on the way may terminate a conversation.

If the contents of a conversation view 1100 are updated after period of time, system 100 may send an alert updating suitable parties through, for example, instances of caregiver application 116 or patient application 108. A user of patient application 108 involved in a previous conversation may be alerted if another party updates the conversation. System 100 may determine whether previous one or more participants of the conversation are still actively using system 100, or whether another participant should be alerted instead. For example, a patient may update a conversation with a caregiver, but the caregiver may no longer be on duty. In such a case, system 100 may select a caregiver who is on-call or on-duty and present the entire communication to the caregiver.

FIG. 12 illustrates an example embodiment of caregiver application 116. Caregiver application 116 may include any suitable number of modules, interfaces, and displays to perform the operation as described herein. Each module may be implemented by any suitable combination of code, logic, applications, scripts, functions, executables, firmware, input/output mechanisms, displays, views, software, or hardware. Specific instances of caregiver application 116 may be selectively adapted for a category of caregiver, such as a nurse, doctor, specialist, EMT, or other healthcare professional.

For example, caregiver application 116 may include a patient assignment module 1202, patient data module 1204, patient communication module 1206, alert module 1208, teaching module 1210, follow-up module 1212, wait-time module 1214, incoming patient module 1216, on-call module 1218, preference module 1220, MD communication module 1222, and a result release module 1224. Each such module may be associated with one or more user screens configured to provide input and output to a user of caregiver application 116.

Patient assignment module 1202 may be configured to allow a user of caregiver application 116 to assign patients of system 100 to various caregivers. Such assignment may be made within a given healthcare entity. Patient assignment module 1202 may be configured to provide a mechanism to select the healthcare entity, such as a hospital or doctor's office. For a given entity, patient assignment module 1202 may be configured to display available, unassigned patients. The view of available patients may be filtered by, for example, patients who have notified the entity that they are on their way, patients in emergency, or patients who have been discharged. Furthermore, the view may be filtered based upon physical location such as room, unit, wing, floor, or building. Patient assignment module 1202 may be configured to allow a user to drag and drop or otherwise add a patient from an available list to a list of patients assigned to the user. Furthermore, patient assignment module 1202 may be configured to similarly allow a user to remove a patient from a list of patients assigned to the user to the list of available patients. Patient assignment module 1202 may be configured to provide searching by name for patients. Patient assignment module 1202 may be configured to allow a user to forward all patients. Thus, the patients assigned to the user may be forwarded to a designated on-call caregiver. Patients may be forwarded using a binary on/off designation, and may be forwarded to an identified on-call caregiver. Similarly, patient assignment module 1202 may be configured to indicate to an on-call caregiver a list of patients who have been forwarded. Such patients may be forwarded to yet another caregiver, such as another on-call caregiver or a specialist, or returned to a caregiver who originally was assigned the patient. Patient assignment module 1202 may be configured to record any such assignment. Such assignments may be recorded to a PHR.

Patient data module 1204 may be configured to display to a user of caregiver application 116 information about one or more patients assigned to the caregiver. Such an assignment may have been made, for example, using patient assignment module 1202. Patient data module 1204 may include a mechanism for selecting an assigned patient or searching available patients. Information, such as that from a PHR for the patient or information uploaded from an EMR, may be selectively displayed.

Patient communication module 1206 may be configured to provide communications for a user of caregiver application 116 to a patient or to other caregivers about a patient. New messages received from patients or other caregivers about patients may be displayed on a per-patient basis. A tabular display or other mechanism may be used to organize separated views of such information on a per-patient basis. Information may be received via text or secured electronic transmission. Such information, as received from patients, may be in templatized form from patient application 108. For a given per-patient view, patient communication module 1206 may display the previous received and sent messages. Furthermore, patient communication module 1206 may include a mechanism for displaying a PHR, viewing test results, medical history, and current medications. In addition, patient communication module 1206 may be configured to provide a shortcut or one-button click to call the room of the patient.

Patient communication module 1206 may include submodules for replying to a patient or communicating with another caregiver. For replying to a patient, patient communication module 1206 may include templatized input or allow free response. Furthermore, patient communication module 1206 may be configured to access the status in system 100 of previously issued orders, such as prescription orders. Patient communication module 1206 may be configured to allow the caregiver to make recorded notes by, for example, typing or voice, based on the communication received. For communicating with another caregiver about a given patient, patient communication module 1206 may be configured to present a list of caregivers, such as doctors or nurses, to whom the communication should be addressed. Furthermore, patient communication module 1206 may be configured to allow a user to forward communication from the patient to the selected caregiver. Patient communication module 1206 may be configured to allow a user to order medications, housekeeping, medical tests, adjust rounds, or obtain paperwork by communicating with another caregiver.

Alert module 1208 may be configured to provide templatized just-in-time medical diagnosis and procedure information to a user of caregiver application 116 based on a given patient's condition. Any suitable set of procedures, checklists, diagnosis charts, or other information may be included. Alert module 1208 may be configured to prompt a user of caregiver application 116 to enter information as observed, conditions checked, or other information that may be unavailable from system 100. Based on the PHR and input from the user of caregiver application 116, alert module 1208 may be configured to guide the user to a diagnosis, next step to take, or additional information to gather to facilitate the treatment of the patient. Alert module 1208 may refer to any suitable set of rules, heuristics, decision trees, care documents, thresholds, recommendations, requirements, exceptions, or other reference data to determine such courses of action to recommend. Such reference data may be updated regularly. In one embodiment, such reference data may include core measures as set by joint medical commissions.

Teaching module 1210 may be configured to allow a user of caregiver application 116 to designate educational, medical information to a designated patient. The patient may view such information, for example, through teaching module 420. For example, a caregiver using caregiver application 116 may direct the patient to view certain videos, read certain information, or listen to certain audio transmissions. Teaching module 1210 may be configured to send such information to the intended recipient and track whether a patient has reviewed such information and answered certain follow-up questions, quizzes, or other mechanisms for affirming understanding. Teaching module 1210 may be configured to inform a user if a user of system 100 has not viewed required information in a specified time frame. Teaching module 1210 may be configured to allow searching of available content. Furthermore, teaching module 1210 may be configured to transmit follow-up checks to a patient after, for example, a delay after a discharge of the patient.

Follow-up module 1212 may be configured to manage and perform follow-up communication between a caregiver and a patient that was previously cared for by a caregiver in system 100. Follow-up module 1212 may include multiple views of patients that may be serviced through outpatient or follow-up medical advice. One such view may include patients assigned to a user of caregiver application 116. Another such view may include unassigned patients in need of follow-up. Yet another such view may be configured to allow a user to initiate follow-up communications with a designated patient. In any given view, follow-up module 1212 may include options for viewing a profile, medical history, PHR, lab results, radiology reports, uploaded data from an EMR, medication lists, or other information about a patient. Furthermore, follow-up module 1212 may include an option for escalating a patient to another caregiver, such as a doctor, or for forwarding the follow-up information to another caregiver.

In one view including patients assigned to a user of caregiver application 116, follow-up module 1212 may be configured to display a list of the assigned patients. Such a list may include a brief summary of each patient including name, age, gender, and when the patient was dismissed. Furthermore, follow-up module 1212 may be configured to display a summary of messages sent to and from the patient. Such a display may be presented in tabular format, for example, to separate the conversations with each patient. Each tab or the list of assigned patients may include a designation of newly received communications as well as an indication of a number of waiting messages. A conversation view with each patient may include a history of messages sent to and from the patient.

In another view for unassigned patients, follow-up module 1212 may display a list of unassigned patients and an indication of a number of messages received from the patient. Follow-up module 1212 may be configured to allow a user to select an unassigned patient and assign the patient to the user or to another designated caregiver. Such configuration may allow a patient to be assigned to an on-call or on-duty caregiver at all times. Consequently, a message received from a patient to a caregiver who is now off-duty may be received by an on-duty caregiver, along with the context of the previous conversation. The on-duty caregiver may be able to respond correctly to the patient's message.

In yet another view, follow-up module 1212 may be configured to allow a user to create a new patient to be included in follow-up communications. Such creation may occur at, for example, discharge of the patient from a facility or upon completion of a visit or procedure. Follow-up module 1212 may include options for selecting a facility, patient, and a number of days after discharge to trigger a follow-up. The follow-up may be automatically sent to the patient using, for example, text, SMS, or a secured electronic message to a user of a patient application 108. The reminder may include, for example, information about medication, rehabilitation, or educational information.

Wait-time module 1214 may be configured to display, for a selected facility, wait times for patients. Such wait times may be determined by determining the number of patients waiting in the facility, the triage information about such patients, the staffing levels of the facility, the number of patients on their way or en-route to the facility, and scheduled arrivals of other patients. Such information may be harvested from system 100. The estimated times may be given according to a sub-category, such as emergency care, urgent care, or minor care. Furthermore, wait-time module 1214 may be configured to display statistics for a given period, such as total visits, patients checked in the last hour or the last three hours, number of admissions to the facility, total number of emergency beds available, and total number of facility beds available. Such information may be harvested from system 100. In one embodiment, such information may be configured to be displayed to a user of patient application 108. Such information may be displayed, for example, in conjunction with a patient selecting a facility to which the patient is en-route.

Incoming patient module 1216 may be configured to manage information regarding patients that are incoming to a health facility or have arrived and are awaiting healthcare service. Incoming patient module 1216 may include one or more views for communication with an EMS service. Such an EMS service may be using EMS application 120. The view of EMS communication may include sequences of messages sent between the user of caregiver application 116 and the EMS service. Such messages may be displayed in a conversation record. The messages may include text, SMS, or other secured electronic messages. Furthermore, voice, video clips, or streaming video may be transmitted between the user of caregiver application 116 and the EMS service and markers for such clips may appear on the conversation display. The view may include an indication of the estimated time of arrival; the name, age, and gender of the patient; a link to the patient's PHR; an identification of the EMS service unit; or special medical information or statuses initiated by the EMS service, such as whether certain procedures have been started. Incoming patient module 1216 may include options for a user to acknowledge reception of a message, make a templatized or free text reply, record a voice clip for a PHR or for reply to an EMS service, or sending information to another caregiver. Furthermore, incoming patient module 1216 may include options for informing system 100 that a designated inbound patient has arrived. Incoming patient module 1216 may include options for removing an EMS transmission from the view.

Incoming patient module 1216 may be configured to determine a location of all incoming patients by GPS or similar information. The mode of transport of each such patient may be determined. The estimated time of arrival, based on, for example, the location of the incoming patient and the mode of transport may be determined. Furthermore, the determined location, estimated time of arrival, and method of arrival of each such patient may be displayed in a map.

Similar to or in conjunction with an EMS view, incoming patient module 1216 may include a view of pre-triage information for a designated patient. Such information may be provided by, for example, an EMS service through EMS application 120 or a patient through patient application 108. Such a view may include details about the condition of a patient that is en route to the facility. The view may include the name, age, and gender of the patient and a link to the patient's PHR. Furthermore, if the patient has arrived or checked in, the view may note the times of such actions. Such information may be harvested from the operation of system 100. Incoming patient module 1216 may include options to designate a patient as arrived or checked-in. Furthermore, incoming patient module 1216 may include options for removing the patient if the patient is being treated, or delaying the patient if conditions warrant.

Furthermore, incoming patient module 1216 may include a view of patients waiting at a healthcare facility for treatment or meeting with a caregiver. Such a view may display such patients that have arrived and checked in to the facility using, for example, patient application 108. The view may include a representation of the arrival time, check-in time, or other information for each patient. Incoming patient module 1216 may be configured to provide patient demographics, links to each patient's PHR, links to previous communication with caregivers at the healthcare facility, or other suitable information. Furthermore, incoming patient module 1216 may be configured to allow a user to change a status of a patient to being moved to a specified location or room, remove a patient from the list, or forward information to another healthcare provider.

In addition, incoming patient module 1216 may be configured to communicate with all or a subset of the patients with a waiting status via message. Such a message may be delivered to, for example, all waiting patients or patients within a specific category of patients.

On-call module 1218 may be configured to provide information about the on-call status of caregivers for a given facility or entity. Such on-call information may be harvested from the operation of system 100. The on-call information may be divided between types of caregivers (such as nurses or doctors), practice specialties, consultants, geographic divisions (such as floor or wing), or facility or entity. Furthermore, on-call module 1218 may include options for a caregiver to select to enter or leave an on-call status, and view patients that are to be added or removed from responsibility. Options for entering on-call status may include a binary selector for the caregiver herself to enter or exit on-call. Furthermore, the options may include an option to selectively choose another caregiver as a recipient of forwarded on-call calls. In addition, on-call module 1218 may include options for specifying a group of caregivers who are all on-call together. In such situations, each such doctor may receive a call for the on-call group. In one embodiment, on-call module 1218 may be configured to disallow a caregiver to remove on-call responsibility until another caregiver accepts on-call responsibility. Such responsibility may include the listing of the specific patients under on-call supervision. On-call module 1218 may be configured to prevent a patient within a given geographic, health status, or other division from being without a caregiver for one or more pluralities of on-call service. For example, a patient in a room at a hospital may be assigned to an on-call nurse and on-call hospitalist doctor by on-call module 1218; on-call module 1218 may then be configured to disallow the on-call nurse to remove their on-call status concerning the patient without assignment of the patient and the on-call status to another nurse. Similarly, on-call module 1217 may be configured to disallow the on-call hospitalist to remove their on-call status concerning the patient without assignment of the patient and the on-call status to another hospitalist. The changeover of on-call assignments may be recorded in the patient's PHR.

Preferences module 1220 may be configured to establish, change, or otherwise manage a user's contact information, preferred name, biography, e-mail address, password, or credentials.

MD communication module 1222 may be implemented in similar fashion to patient communication module 1206, but may be configured to provide additional functionality for caregiver-to-caregiver communications. Such functionality may include, for example, physician-to-physician communication, nurse-to-physician communication, physician-to-EMS communication, or nurse-to-nurse communication. MD communication module 1222 may include a view of patients currently assigned to a caregiver, similar to views presented in patient assignment module 1202 or patient data module 1204. MD communication module 1222 may include options for calling, messaging with templates, or otherwise contacting another caregiver or a director of a healthcare facility directly

Furthermore, MD communication module 1222 may include a view of consultations. Such consultations may be made between two or more caregivers to collaborate on diagnosis, treatment, or other healthcare issues of a given patient. A consultation may be stored as a self-contained or compartmentalized aspect of a PHR or other data structure of system 100. The consultation view may include options for creating a new consultation with one or more other caregivers. The options for creating a new consultation may include a feature for selecting a consultation subject, such as a newly admitted patient, a patient recovering from a treatment or procedure, a proposed treatment or procedure for a patient, or other healthcare topic. Furthermore, the options for creating a new consultation may include a feature for selecting a time frame and a feature for selecting a location in which the consultation should take place. In addition, a feature may be included for specifying whether follow-up with the requesting caregiver is required, optional, necessary before the consultation, or necessary after the evaluation. A feature may be included giving an initial diagnosis. Furthermore, features may be included for attaching voice, video, free-text, or images made with a device powering MD communication module 1222 in relation to the consultation.

The view of consultations may also include a view of requested consultations and options for replying to such consultations. Possible consultations may be presented in text form, assembled by MD communication module 1222 from the options selected by a user thereof. Options may be provided for designating, from a list of choices, actions that will be taken in response to the requested consultation, such as whether admission, treatment, or other activities will be taken, and for which patient. Furthermore, options may be provided for responding that the user of MD communication module 1222 is not on-call or is otherwise unavailable to take the consultation. The request may be selectively forwarded to another caregiver. A selection of possible caregivers may be generated by MD communication module 1222, including, for example, caregivers using system 100 or caregivers with an active on-call status. Furthermore, the view of consultations may include a view for sending a callback request to another consulting caregiver.

In addition, MD communication module 1222 may include a view of messages received from other caregivers. Such messages may include proposed consultations or other messages. The view of messages may indicate a caregiver requesting the consultation, a timestamp, a referenced patient, and whether the message was delivered and read. Once a message is selected, a conversation window may be used to display messages sent and received between the caregivers. Messages may be forwarded to another caregiver using system 100 or to an on-call pool of caregivers. Each such selection may be made from an available list.

Also, MD communication module 1222 may include a view of messages that may be selectively displayed on a per-patient basis. Such messages may include a conversation display of messages to and from other caregivers regarding the given patient. Conversations may be selected by, for example, choosing a facility and choosing a patient from a list of available or assigned patients in such a facility.

Result release module 1224 may be configured to provide information about lab results, procedure results, or other treatment results for a given patient and provide features for selectively releasing the information to a user of patient application 108. In one embodiment, result release module 1224 may highlight lab results that are critical or sensitive to a user of caregiver application 116. For a given patient, a list of lab results may be presented. Shortcuts to communications modules, such as patient communication module 1206 or MD communication module 1222, may be presented in-line or in conjunction with a given result. Use of such a shortcut may pre-populate communication with another user of system 100 using patient application 108 or caregiver application 116 with the test results. Furthermore, options to release or not release a given result may be provided to the user of result release module 1224. Selection of no release may trigger result release module 1224 to schedule a follow-up conversation with the patient in question. Selection of release may permit viewing of the result on the PHR by the patient and may generate a text message that is sent to the patient via system 100. Furthermore, result release module 1224 may include options to release all results for a given patient, or to selectively release the results with comments to be entered by the user of result release module 1224.

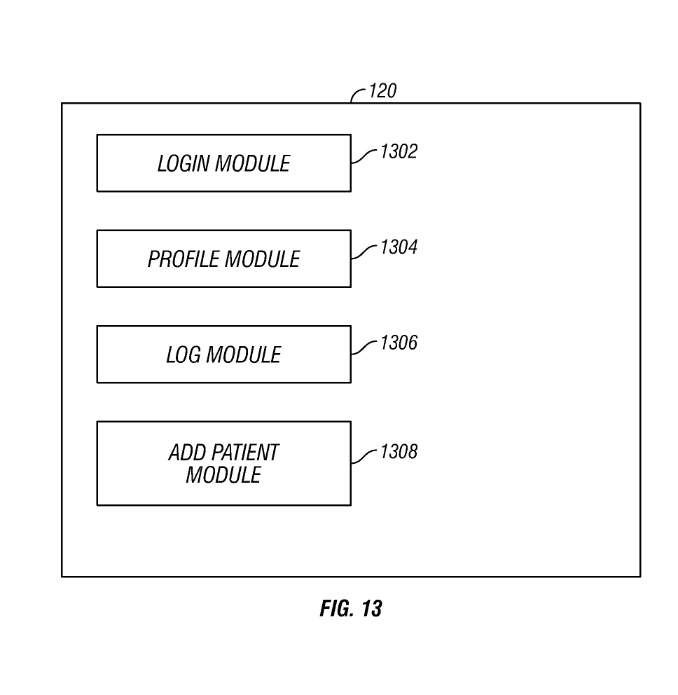

FIG. 13 illustrates an example embodiment of EMS application 120. EMS application 120 may include any suitable number, kind, or combination of components to perform the functionality described herein. For example, EMS application 120 may include a login module 1302, profile module 1304, log module 1306, and add patient module 1308. Each of login module 1302, profile module 1304, log module 1306, add patient module 1308, and other elements of EMS application 120 may be implemented by any suitable application, script, executable, logic, instructions, functions, hardware, software, firmware, input/output mechanisms, displays, views, or any suitable combination thereof.

Login module 1302 may be configured to provide the ability for a user, such as an EMT, to log in to EMS application 120 and, consequently, system 100. Login may be conducted in any suitable manner, such as by scanning of a QR code, username and password, personal identification number, or any combination thereof.

Profile module 1304 may be configured to allow a user of EMS application 120 to enter or view user information. Such information may include, for example, first and last name, photograph, identification number, and contact information.

Log module 1306 may be configured to track, record, or display a log of transported patients. Such information may be recorded from previous operation of EMS application 120. Information including, for example, patient identification number, age, gender, pick-up location, and destination location may be included for each such patient. Furthermore, each such patient entry may be retrievable to determine additional recorded data from the operation of EMS application 120, equipment used, notes or communication made, or other data associated with the patient. In addition, active patients currently in contact with a user of EMS application 120—for example, patients currently being transported—may be displayed separately from previously transported patients.

Add patient module 1308 may be configured to allow a user of EMS application 120 to add a patient upon pick-up, assistance, or other contact. A patient may be added, for example, by scanning a QR code of the patient to look the patient up in system 100, the patient logging in, or another release of the patient's information to system 100 and, specifically, to EMS application 120. Such a release may include a push of information from the patient's PHR to EMS application 120. In one embodiment, such a push of information may include a selective push of the information from the PHR. The selection of a patient to be added to EMS application 120 may be made from a list of possible patients.

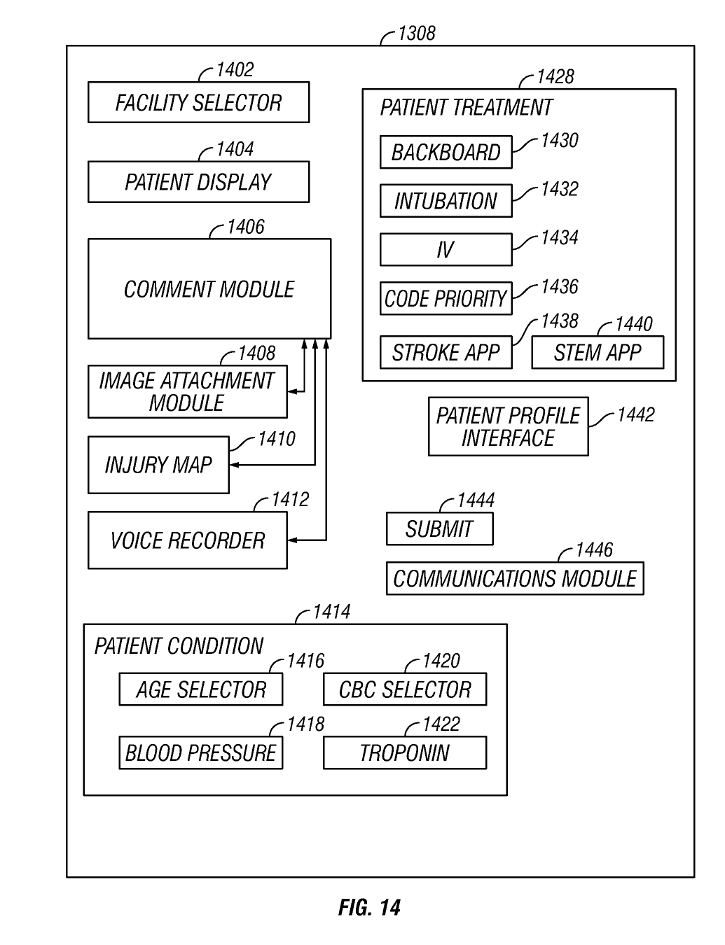

FIG. 14 is an illustration of an example embodiment of add patient module 1308 once a patient has been selected to be added to EMS application 120. Add patient module 1308 may include any suitable number, kind, or combination of components to perform the functionality described herein. For example, add patient module 1308 may include a facility selector 1402, patient display 1404, comment module 1408, injury map 1410, voice recorder 1412, patient condition module 1414, patient treatment module 1428, patient profile interface 1442, submit option 1444, and communications module 1446. Each of facility selector 1402, patient display 1404, comment module 1408, injury map 1410, voice recorder 1412, patient condition module 1414, patient treatment module 1428, patient profile interface 1442, submit option 1444, communications module 1446, and other elements of add patient module 1308 may be implemented by any suitable application, script, executable, logic, instructions, functions, hardware, software, firmware, inputs/outputs, views, displays, or any suitable combination thereof.

Facility selector 1402 may be configured to allow selective input and display of a facility to which a patient being treated will be transported. In one embodiment, a user of add patient module 1308 may select the facility. In another embodiment, the facility to which the patient will be sent may be determined by system 100 and pushed to EMS application 120. Such a determination may be based upon, for example, the condition of the patient, the symptoms of the patient, the time of the onset of the symptoms, the distance to a given facility, and the services, personnel, wait times, or equipment of the given facility.

Patient display 1404 may be configured to display information about the patient associated with use of EMS application 120. The information may include identifying information. In one embodiment, such information may be pre-populated from the push of information from the PHR from system 100 to EMS application 120, or from the receipt of such information directly from a sign-in of the patient.

Comment module 1406 may be configured to display pending communication or other information to be communicated from a user of EMS application 120. Comment module 1406 may include displays for text, icons representing additional data such as a voice clip or image, or any other suitable communication. Comment module 1406 may be communicatively coupled to other elements for inputting comments, such as image attachment module 1408, injury map 1410, or voice recorder 1412. Image attachment module 1408 may include mechanisms for attaching a photograph previously created or for taking a photograph with equipment on or coupled to the electronic device upon which EMS application 120 is executing. Injury map 1410 may include a stylized map of a person and provide options for a user of EMS application 120 to select which portion of a patient's body requires medical attention. Injury map 1410 may be implemented in similar fashion to body map option 842 as described above. Voice recorder 1412 may be configured to allow a user of EMS application 120 to record notes regarding the patient. Voice recorder 1412 may be implemented, for example, using features or equipment upon an electronic device upon which EMS application 120 is executing. The output of image attachment module 1408, injury map 1412, or voice recorder 1412 may be assembled and represented in comment module 1406. Comment module 1406 may include a keyboard input display or otherwise accept keyboard input to include free text.

Patient condition 1414 may include one or more inputs or outputs for indicating and recording the present condition of a patient. Such inputs may be configured to be set by a user of EMS application 120, automatically imported from a medical device, or obtained in any other suitable manner. In one embodiment, such inputs may be received and unalterable, and may be displayed only as outputs. Patient condition 1414 may include any suitable combination of inputs and outputs for setting or indicating the present condition of a patient. For example, patient condition 1414 may include an indicator 1416 for indicating the patient's age, an indicator 1418 for indicating the patient's blood pressure, an indicator 1420 for indicating the patient's complete blood count (CBC), and an indicator 1422 for indicating the patient's troponin level. Other conditions recorded, indicated, determined, or reported by patient condition 1414 may include electrocardiograph data, heart rate, blood sugar, or any other instantaneous patient wellness data. In one embodiment, one or more of the elements of patient condition 1414 may be entered by a user of EMS application 120. In another embodiment, one or more of the elements of patient condition 1414 may be gathered or determined by communication between EMS application 120 and one or more medical devices.

Patient treatment 1428 may include one or more inputs for indicating and recording treatments that have been applied to the patient. Such inputs may include options for entering or indicating use of backboard 1430, intubation 1432, or intravenous (IV) treatment 1434. Other inputs may include options for indicating the application of a number and kind of IV treatments, injections, pain medication applied, cardio-pulmonary resuscitation, or defibrillation. Furthermore, patient treatment 1428 may include an input for selecting a code priority 1436, indicating a severity or priority associated with the patient's condition. In addition, patient treatment 1428 may include or be communicatively coupled to one or more specialized application. Such specialized applications may include, for example, an application 1438 for entering detailed information about a stroke patient or an application 1440 for entering detailed information about a ST segment elevation myocardial infarction (STEMI) patient.

Patient profile interface 1442 may include any suitable mechanism for accessing, updating, or recording information to or from a PHR or other profile of the patient. Submit 1444 may include an option for a user of EMS application 120 for submitting the information collected in, for example, add patient module 1308 to system 100 and, more particularly, to a facility to which the patient will be transported.

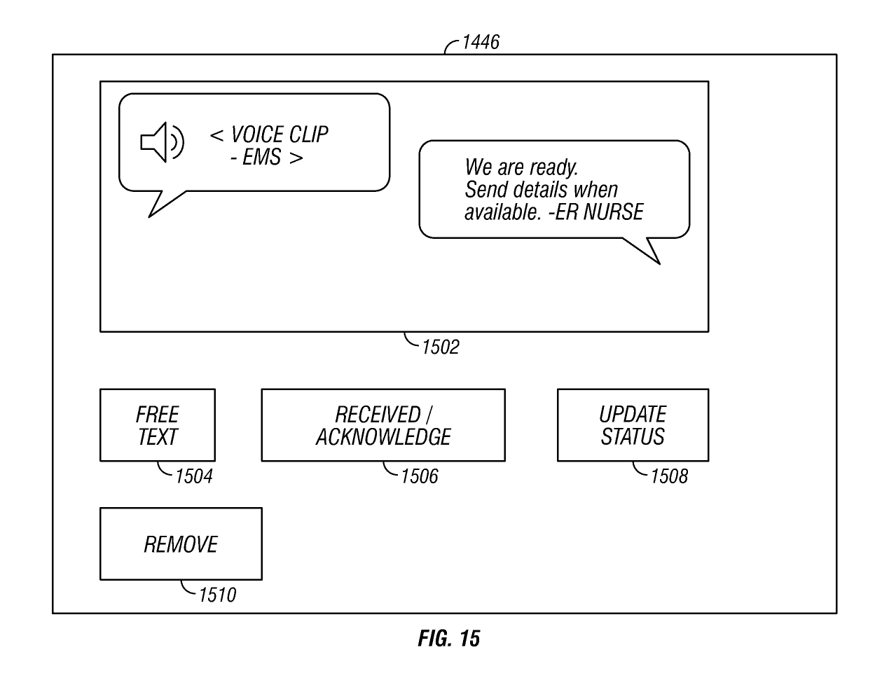

Communications module 1446 may be configured to facilitate communication between a user of EMS application 120 and another caregiver of system 100. Such communication may be initiated by selection of submit 1444. Communications module 1446 may be configured to send or receive messages from EMS application 120 as shown in FIG. 15.

FIG. 15 is an illustration of an example embodiment of communications module 1446. In addition to the components illustrated in FIG. 15, communications module 1446 may also include any of the options, modules, or input-output mechanisms described above, such as image attachment module 1408, injury map 1410, or voice recorder 1412. Communications module 1446 may include a conversation display 1502 configured to display the back-and-forth communications from a user of EMS application 120 and another caregiver. The display of communications may include, for example, text, an icon or pictogram of a voice clip, or an icon of a pending photograph. Furthermore, communication module 1446 may include a free text input, for which text may be freely entered by a user of EMS application 120. In addition, communication module 1446 may include an acknowledgment input 1506. Acknowledgment input 1506 may be configured to provide one-click or one-press acknowledgment communication to a sender of a message that the information has been received and acknowledged. Also, communications module 1446 may include an update status 1508 input. Update status 1508 input may be configured to resend information that was previously sent, such as that information presented in FIG. 14. Communications module 1446 may include a remove 1510 input, configured to remove communications or information that are pending a selection of, for example, update status 1508.

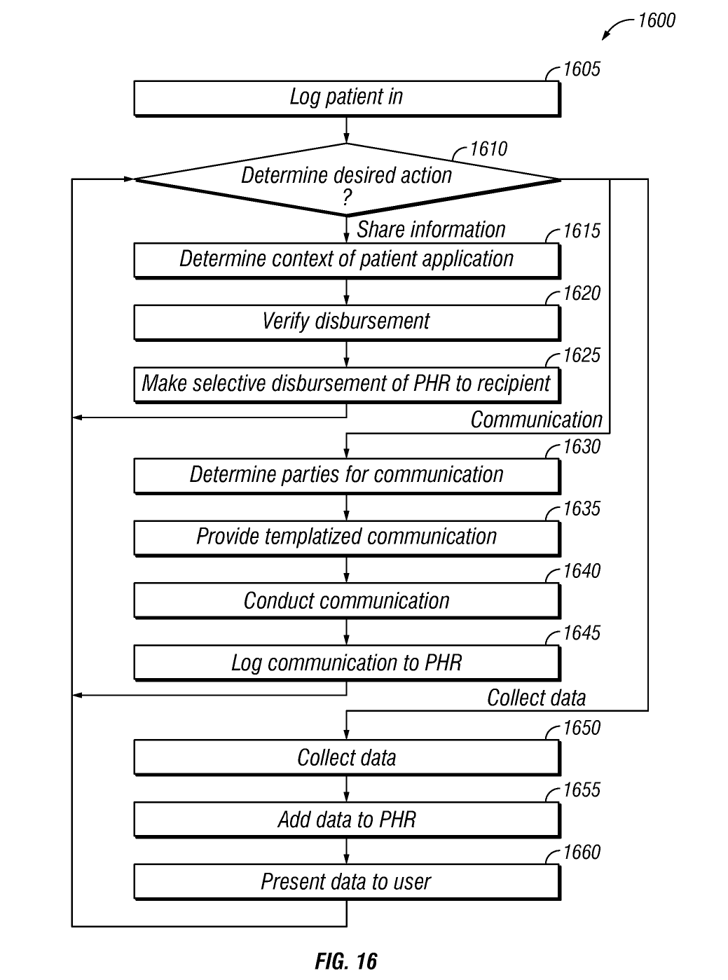

FIG. 16 illustrates an example embodiment of a method 1600 for medical information tracking. Method 1600 may perform any number or kind of steps in accordance with the configuration of system 100 as described above. For example, in 1605, a patient may be logged into a system for medical information tracking. Such a log-in may be performed by, for example, scanning a QR code provided by the patient, or by a username and password. The log-in of the patient may retrieve or otherwise make available a PHR associated with the patients.

In 1610, a desired action may be determined. Such a determination may be made on, for example, an application used by the patient in the system, or by an application used by another entity in the system. Depending upon the action determined, method 1600 may proceed to a suitable course of action.

If a share of information is determined to be desired, then in 1615 a context of the operation of patient application (or another application generating the share) may be determined. The context may be used to determine what portions of PHR are to be disbursed. The share may have been requested by, for example, a caregiver, or may have been initiated by the patient. The share may be handled by the system, such that requests and pushes of information may be centrally processed for authorization from the patient. Authorization for disbursement of the selected portions of the PHR may be verified in 1620. In 1625, the selective disbursement may be performed. Method 1600 may return to 1610.

If communication is determined to be desired, in 1630 the parties associated with the communication may be determined. In one embodiment, the communication may be made to an on-duty or on-call caregiver, or to a specified caregiver who is unavailable and thus has authorized on-duty or on-call caregivers to respond. An on-duty or on-call status may be preserved by the system such that at least one, or another minimum number, of a category of caregivers is available. In another embodiment, the communication may be made to a designated caregiver who is available. Communication transfer mediums and mechanisms may be secured. In 1635, templatized communication may be provided. Such templatized communication may present one or more predetermined forms for communicating medical information. In 1640, the communication may be conducted. In 1645, the communication may be logged. In one embodiment, such logging may be conducted to the PHR. Method 1600 may return to 1610.

If collecting medical data is desired, the in 1650 the data may be collected. The data may be input from a medical device, manually by a caregiver, or manually by a patient. The data may include any suitable medical data, such as a lab report, symptom details, or vital signs. In 1655, the data may be added to a PHR. In 1660, the data may be selectively presented to a user. Such selective presentation may include, for example, a delivery of only needed or relevant information for a given caregiver. Furthermore, such selective presentation may include a notification to a patient that a lab test is available, but given the sensitive contents or context of the lab test, the information will be available directly from a caregiver. Method 1600 may return to 1610.

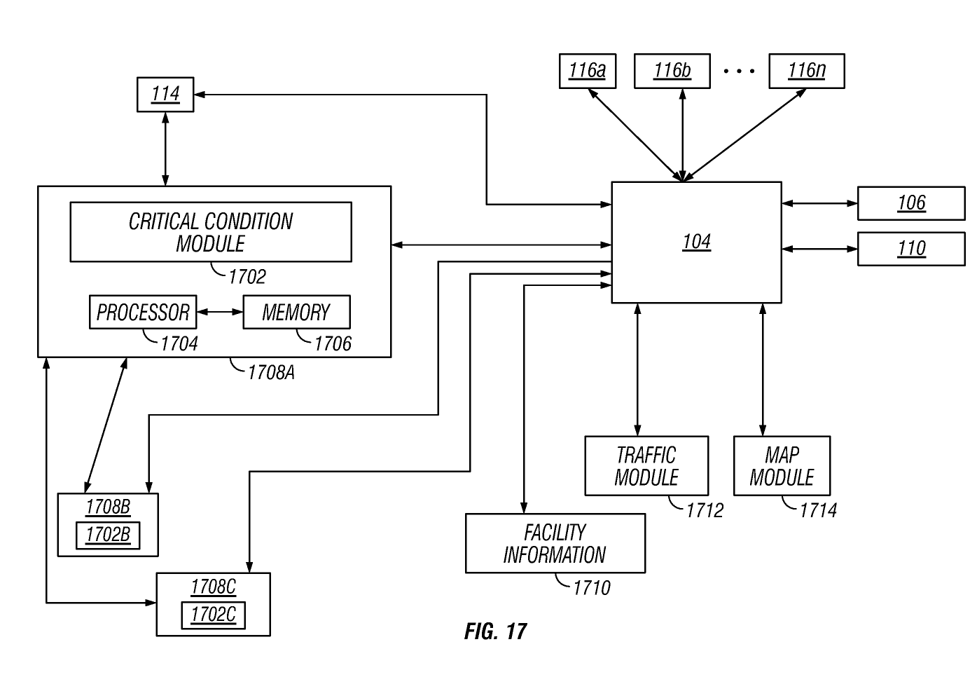

FIG. 17 is an illustration of an example embodiment of system 100 configured to provide condition-specific information tracking. Such tracking may be facilitated by, for example, critical condition module 1702. Critical condition module 1702 may be configured to provide communication, real-time determinations, and information specific to one or more designated medical conditions. In one embodiment, critical condition module 1702 may be configured to provide such functionality with respect to treatment of a STEMI condition. In another embodiment, critical condition module 1702 may be configured to provide such functionality with respect to treatment of a stroke condition.

Critical condition module 1702 may implement fully or in part one or more applications described above such as server application 104, administration application 112, caregiver application 116, or EMS application 120. Furthermore, critical condition module 1702 may be implemented in any suitable fashion, such as by modules, logic, instructions, executables, libraries, functions, scripts, applications, hardware, software, firmware, input/output mechanisms, displays, views, or any suitable combination thereof. The functionality used within a given instance of critical condition module 1702 may be selectively provided based upon a user or a classification of user of critical condition module 1702. For example, the functionality of critical condition module 1702 may be selectively presented to or used by an EMS worker, technician, nurse, or physician.

Critical condition module 1702 may be resident within an electronic device 1708, which may include a processor 1704 coupled to a memory 1706. Some or all of critical condition module 1702 may be implemented by instructions or logic in memory 1706, which may include a computer-readable medium. The instructions may be executable by processor 1704 and, when executed, perform the functionality described herein. Execution by processor 1704 may cause one or more changes within the processor, such as to encoders, decoders, caches, or registers.

To perform various aspects of its functionality, or in the course of performing such functionality, critical condition module 1702 may be communicatively coupled to one or more other portions of system 100, such as server application 104, caregiver application 116, patient application 108, administration application 112, EMS application 118, registration application 121, or other instances of critical condition module 1702. Such communicative coupling may be performed by, for example, a suitable network such as a wireless network.

Server application 104 may be configured to access various entities, such as databases, sources of information, web services, functions, applications, to provide information to critical condition module 1702. In one embodiment, critical condition module 1702 may be configured to directly access such information.

For example, server application 104 may be configured to access facility information 1710. Facility information 1710 may be implemented by, for example, a database, file, web service, function, or module. Facility information 1710 may be configured to provide information about a given healthcare facility, such as testing capabilities of the facility, staffing levels of the facility, wait times, availability of specific equipment or laboratories or tests, readiness times for specific equipment or laboratories or tests, or on-duty statuses of professionals.

In another example, server application 104 may be configured to access map module 1714. Map module 1714 may be implemented by, for example, a database, file, web service, function, or website. Map module 1714 may be configured to provide information about distances, expected times of arrival, or other information for travel between two locations. Such locations may include, for example, a location reported by a patient or EMS personnel, or one or more healthcare facilities. Server application 104 may further utilize traffic module 1712, alone or in conjunction with map module 1714. Traffic module 1712 may be implemented by, for example, a database, file, web service, function, or website. Traffic module 1712 may provide real-time information about traffic congestion, hazards, closures, or other information that may augment information from map module 1714. Information from map module 1714 may be augmented in real-time with information from traffic module 1712 to determine estimated travel times or estimated arrival times between two locations.

Critical condition nodule 1702 may include any suitable combination of inputs, outputs, submodules, functions, or other features or components to effect the functionality. Described herein. Wherein a particular such feature or component is described, any suitable mechanism may be used to implement the feature or component.

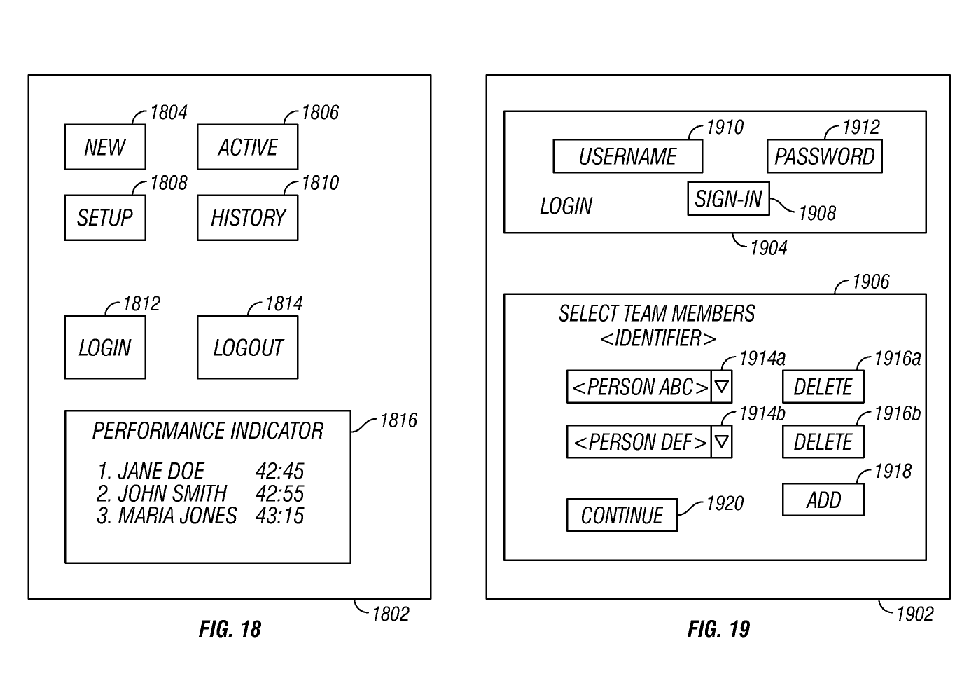

For example, FIG. 18 illustrates an example embodiment of a main menu view 1802 for critical condition module 1702. Main menu view 1802 may include an option 1804 for creating a new instance of a patient with a designated condition that is to be tracked by system 100 through use of critical condition module 1702. Option 1804 may create a new instance of a patient with a condition defined by the instance of critical condition module 1702, or may provide choices to designate what condition is to be handled. For example, an instance of critical condition module 1702 may implement functionality specific to a STEMI condition. In such an example, option 1804 may create a new patient instance with STEMI. In another example, an instance of critical condition module 1702 may implement functionality specific to a stroke condition. In such an example, option 1804 may create a new patient instance with stroke. In yet another example, option 1804 may subsequently present to a user a choice of creating a patient instance of a STEMI or stroke condition.

Option 1806 may provide users the ability to view all open or active patient instances. Option 1806 may provide such a view with active patients with a condition specific to the functionality of the instance of critical condition module 1702 or provide users with a subsequent choice of conditions for which associated active patients will be retrieved.

Option 1808 may provide users the ability to change user, team, or application configuration information. Option 1810 may provide a view into past patient instances handled by critical condition module 1702. Option 1812 and option 1814 may provide login and logout functionality, respectively.

Performance indicator 1816 may provide an indication of an individual or team that has utilized critical condition module 1702 and an associated metric indicating a level of performance associated with the condition. Such a metric may include, for example, the time taken from a point of contact with a patient—such as an EMS pickup, onset of symptoms, or arrival from EMS to a healthcare facility—to initiation or completion a treatment. The metric may be given in absolute terms for a specific patient instance or in average terms over a specified time period. Performance indicator 1816 may be determined by storing and averaging results from use of critical condition module 1702.

FIG. 19 is an illustration of an embodiment of a view 1902 for logging in users to critical condition module 1702. View 1902 may be triggered by, for example, option 1812, option 1814, or option 1808. View 1902 may include view 1904 configured to provide login operations. Elements of view 1902 may be pre-populated by, for example, use of an external identifier such as a radio frequency identification (RFID) tag, to log in automatically. View 1902 may include options for username 1910, password 1912, and logging in 1908.

Furthermore, various team members associated with the user of critical condition module 1702 may be identified in view 1902. For example, view 1906 may include options 1914 for selecting a fellow user of an instance of critical condition module 1702 or options 1916 for removing such a user. Furthermore, view 1906 may include an option 1918 to add an additional user and an option 1920 to continue.

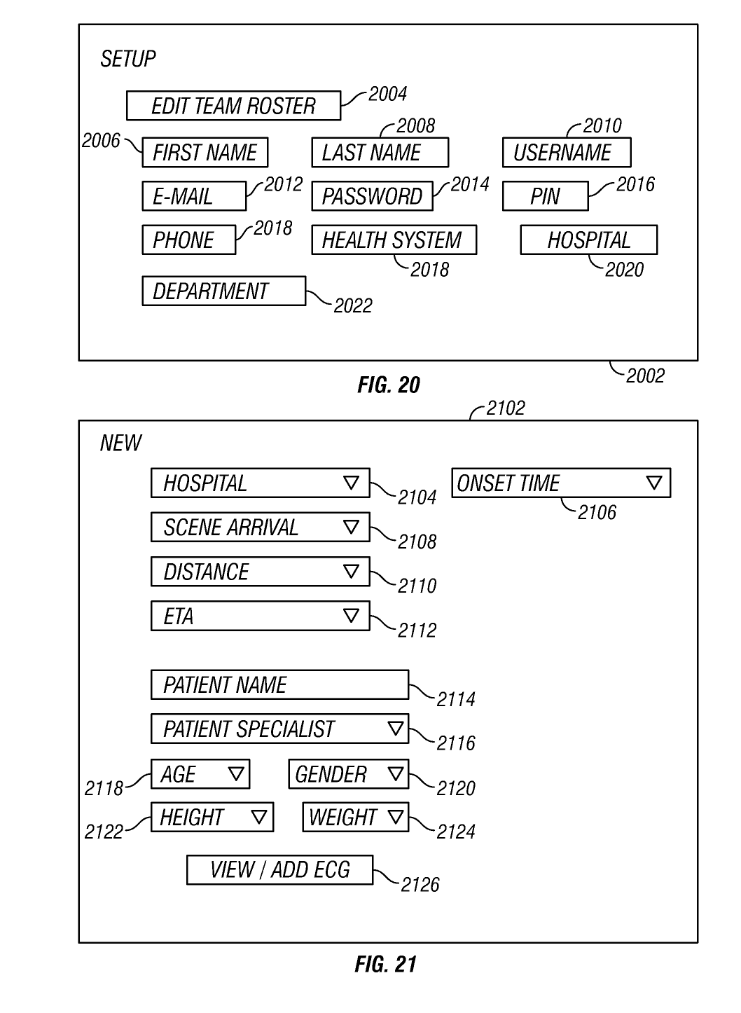

FIG. 20 is an illustration of an embodiment of a view 2002 for setting up an instance of or configuring a user of critical condition module 1702. View 2002 may be triggered by, for example, option 1808. View 2002 may include an option 2004 to edit a team roster. Use of option 2004 may trigger, for example, view 1906. Furthermore, view 2002 may include options 2006, 2008, 2010 for first name, last name, and user name, respectively. Login credentials such as an operation 2014 for a password and an option 2016 for a personal identification number may be included, which may be used in conjunction with view 1902. Contact information, such an option 2012 for setting e-mail information or an option 2018 for setting telephone information may be included. Furthermore, association information, such as an option 2018 to designate a system of healthcare facilities associated with the user, an option 2020 to designate a specific facility of the system, or an option 2022 to designate a specific department of the system. Options 2018, 2020, 2022 may be pre-populated according to information associated with the user of critical condition module 1702. Such information may be obtained from, for example, server application 104. Furthermore, the choices available in options 2018, 2020, 2022 may determined from information in, for example, server application 104. The choices available in option 2020 may be determined by selection of a value of option 2018. Furthermore, the choices available in option 2022 may be determined by selection of a value of option 2020.

FIG. 21 is an illustration of an embodiment of a view 2102 for setting up a new instance of a patient treatment in conjunction with critical condition module 1702. View 2102 may be triggered by, for example, option 1804. View 2102 may be configured to capture or establish necessary information to initiate treatment of a patient. View 2102 may be configured to be specific to a particular critical condition, such as a stroke or STEMI. Such a configuration may result in more or less options or views that are applicable to the particular critical condition.

View 2102 may include an option 2804 to designate a hospital or other healthcare facilities to which the patient will be transported. Option 2804 may be selected by a user of critical condition module 1702 from a list of available facilities. Available facilities may be determined by, for example, selection of option 2018. Option 2804 may be pre-populated according to, for example, option 2020. Furthermore, the choices of option 2804 may be pre-populated by, for example, server application 104 according to the nearest facility (in terms of distance or transit time). The facility selection may be also pre-populated according to wait times, equipment availability, or based upon the specific condition handled by critical condition module 1702.

View 2102 may include an option 2106 for setting an onset time. Such a time may designate the time at which symptoms associated with the condition began. A user of view 2102 may set option 2106 based on, for example, a time of an emergency call or information from the patient or a witness.

View 2102 may include an option 2108 to set an arrival time. Such an arrival time may designate a time at which a user of view 2102 arrived at a location of the patient. The arrival time may be pre-populated based on geospatial information from another source in network 100, such as a GPS device associated with the user of option 2108.

View 2102 may include an option 2210 to designate distance to the selected facility. Option 2210 may be populated according to a calculated distance based upon prior selection of option 2804. Furthermore, option 2210 may change if option 2804 is changed.

View 2102 may include an option 2212 to designate an estimated time of arrival to the selected facility. Option 2212 may be populated according to the calculated distance of option 2210, in addition to real-time traffic and geospatial information according to maps which may designate speed limits, traffic devices, and similar factors for travel-time. Option 2212 may change if options 2804 is changed. Furthermore, option 2212 may change depending upon, for example, the geographic location of a user of view 2102, traffic, or conditions affecting traffic.

View 2102 may include options for information about the patient. Such information may be pre-populated according to usage of patient application 108. View 2102 may include, for example, an option 2114 for patient name, an option 2118 for patient age, an option 2120 for gender, an option 2122 for height, or an option 2124 for height. A user of view 2102 may select each of such options. Furthermore, view 2102 may include an option 2116 to designate a physician, such as a specialist, associated with the patient. Option 2116 may be pre-populated according to a selection of the patient, whether the patient is selected by a user of view 2102 or through use of patient application 108. Furthermore, option 2116 may include choices determined from physicians available at the facility designated in options 2104.

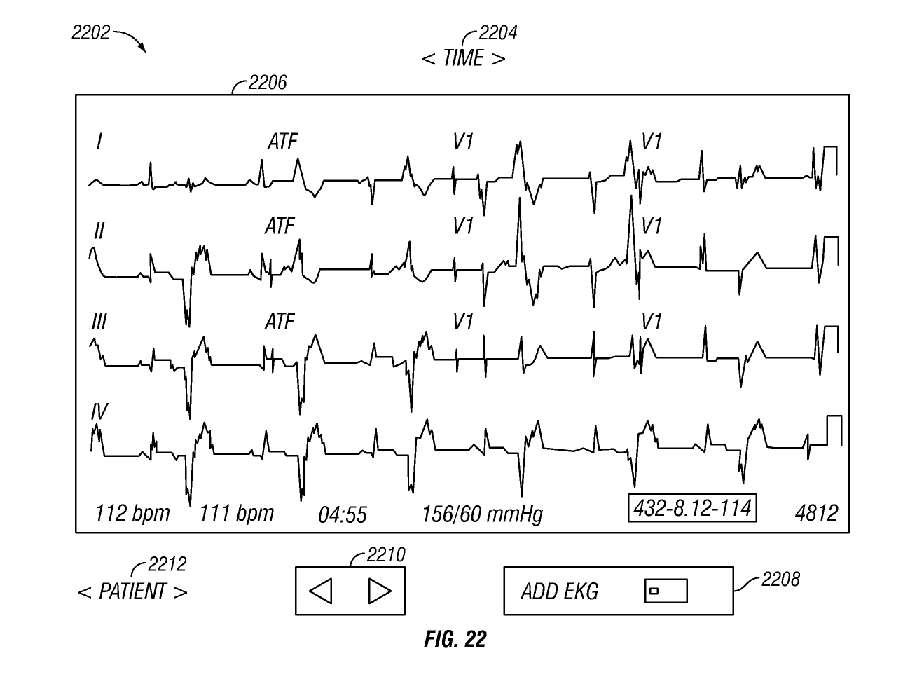

View 2102 may include an option 2126 for selecting an electrocardiogram (EKG) associated with the patient. FIG. 22 is an illustration of an embodiment of a view 2202 for obtaining an EKG. A time 2204 that the EKG is taken may be set or displayed. An identifier 2212 illustrating the patient whose EKG is being taken may be displayed. Option 2208 may be used to import an EKG from an external piece of equipment or to take a picture of an EKG using a camera associated with the electronic device upon which view 2202 is operating. Setting up a new instance of a patient treatment in conjunction with critical condition module 1702. Selector 2210 may switch views of a plurality of EKGs that have been taken of the patient. View 2306 may display the currently selected EKG.

Returning to FIG. 21, upon selection of necessary options in view 2102, a new instance of patient treatment may be created. Information from view 2102 may be sent to, for example, other instances of critical condition module 1702, or to server application 102 for disbursement to other applications as necessary. Such sharing of information may be used to, for example, notify necessary parties to prepare for the arrival of the patient. Furthermore, event timing may be initiated to coordinate and evaluate treatment options.

Critical condition module 1702 may be configured to facilitate treatment of a patient that has been initiated at any suitable time and upon any suitable basis. In one embodiment, FIG. 21 may illustrate view 2102 to be used by an EMS professional upon arrival at a patient's location and initiating of treatment and transport.

In another embodiment, critical condition module 1702 may be used by professionals initiating treatment for patients who have transported themselves to a healthcare facility such as a hospital. In such an embodiment, door times and other information may be set to the time that a patient arrived. Furthermore, estimated arrival times may be unused, unless the patient requires transport to a different facility. A time of first medical contact may be set to the arrival time.

In yet another embodiment, critical condition module 1702 may be used by professionals initiating treatment for patients who are already admitted to a healthcare facility such as a hospital. In such an embodiment, door times, scene arrival, and estimated times of arrival may be unused, unless the patient requires transport to a different facility. A time of first medical contact may be set to a time of initiated contact within the healthcare facility with respect to the condition.

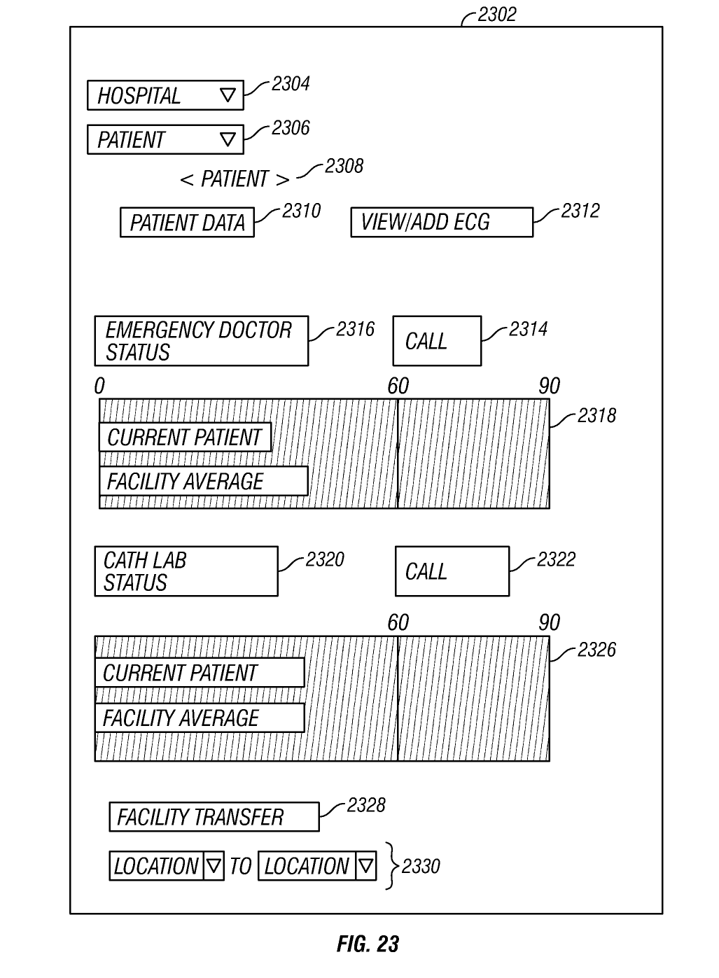

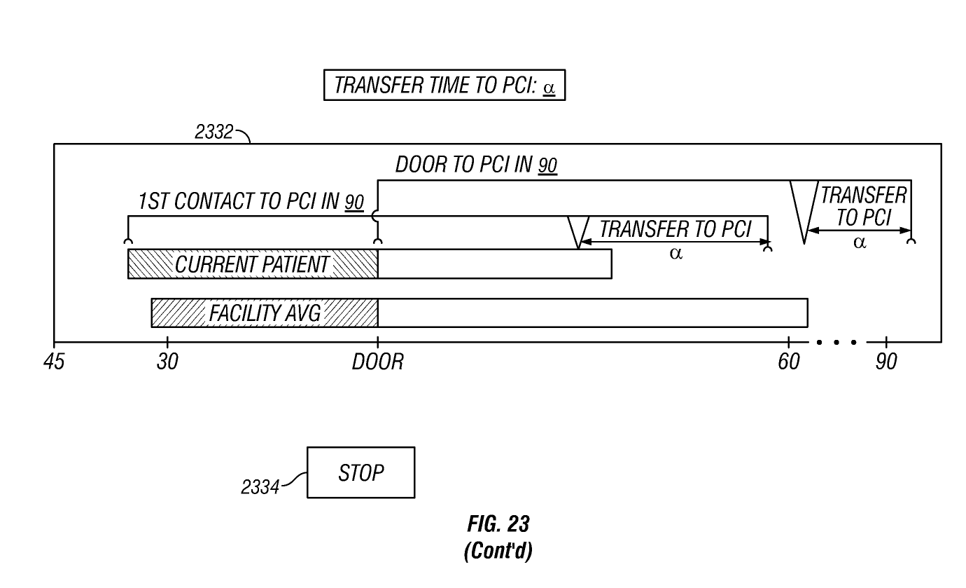

FIG. 23 is an illustration of a view 2302 of an instance of an active treatment of a patient using critical condition module 1702. View 2302 may be configured to illustrate treatment associated with, for example, a STEMI condition.

View 2302 may include an option 2304 designating a chosen facility and an option 2306 designating the patient. Such options may be pre-populated from selections of view 2102. An indication 2308 may be displayed illustrating the chosen patient.

View 2302 may include an option 2310 for displaying or editing patient data. Such information may be populated according to information accessible by, for example, server application after a patient has logged in to system 100. View 2302 may include an option 2312 for adding or viewing an EKG, which may be implemented in similar fashion to option 2126.

Upon creation of a new treatment instance, alerts may be sent to other users of critical condition module 1702 or other applications of system 100. Such alerts may include, for example, alerts sent to cardiologists, other physicians, or other specialists. Such users may be able to respond to alerts, which may be delivered to other instances of critical condition module 1702. View 2302 may include an option 2316 for illustrating whether or not a responsible, on-duty, or otherwise designated physician is prepared to receive the patient. In instances of view 2302 for use by such a professional, option 2316 may include the ability for the professional to activate readiness. Selection of option 2316 in such cases will acknowledge previously sent alerts. Furthermore, option 2316 in other instances of view 2302 used by other users of system 100 may be updated to reflect the status of such a physician. View 2302 may include an option 2314 to contact the designated physician, such as by telephone, text, or e-mail.

View 2302 may include an indicator 2318 of performance with regards to the activation of the designated physician status. Indicator 2318 may illustrate time elapsed from an initialization until activation of the designated physician status by use of option 2316. The initialization may include, for example, onset time, scene arrival time, or facility arrival time. Such times may be automatically determined through options selected in critical condition module 1702 or through information inferred from the use of critical condition module 1702. Indicator 2318 may illustrate the time elapsed with regards to the current patient. Furthermore, indicator 2318 may illustrate the average time required for designated physicians to set an active status. Such an average time may be established, for example, for a given facility, network, or over a given time period. Upon setting of option 2316, performance may be evaluated and displayed in, for example, performance indicator 1816, if such performance meets display criteria.

View 2302 may include an option 2320 for illustrating whether or not a laboratory, technician, or other responsible entity for a designated test is prepared to receive the patient. Such an entity may include, for example, a catheter laboratory capable of performing a percutaneous coronary intervention (PCI). In instances of view 2302 for use by a professional associated with such a laboratory, option 2320 may include the ability for the professional to activate readiness. Selection of option 2320 in such cases will acknowledge previously sent alerts. Furthermore, option 2320 in other instances of view 2302 used by other users of system 100 may be updated to reflect the status of such a laboratory. View 2302 may include an option 2322 to contact the designated laboratory, such as by telephone, text, or e-mail.

View 2302 may include an indicator 2326 of performance with regards to the activation of the designated laboratory status. Indicator 2326 may illustrate time elapsed from an initialization until activation of the designated laboratory status by use of option 2320. The initialization may include, for example, onset time, scene arrival time, or facility arrival time. Such times may be automatically determined through options selected in critical condition module 1702 or through information inferred from the use of critical condition module 1702. Indicator 2326 may illustrate the time elapsed with regards to the current patient. Furthermore, indicator 2326 may illustrate the average time required for laboratories to set an active status. Such an average time may be established, for example, for a given network, facility or over a given time period. Upon setting of option 2320, performance may be evaluated and displayed in, for example, performance indicator 1816, if such performance meets display criteria.

View 2302 may include an option 2328 for facility transfer. Such an option may display or designate choices for moving the present patient to another facility. The other facility may have, for example, laboratory equipment or at least available such equipment. Selection of option 2328 may cause population of options 2330, wherein the present facility is selected and possible destination facilities are made available. The closest facility, in terms of distance or time, with a necessary laboratory such as a catheter laboratory, may be pre-populated. View 2302 may determine such information from, for example, communication with server application 104. The necessary time for transfer may be updated in real-time according to present travel conditions and used as discussed below. Upon selection of option 2328 for facility transfer, other existing users of critical condition module 1702 associated with the treatment of the patient may be notified by an alert that the patient is to be transferred. Furthermore, alerts will be sent to users of critical condition module 1702 associated with the facility to which the patient will be transferred. The set of users at the new facility receiving such alerts may correspond to the equivalent set of users for the original facility that received alerts upon initiation of treatment.

View 2302 may include an indicator 2332 illustrating progress of a patient. Indicator 2332 may be assembled from, for example, information determined by inputs to critical condition module 1702 or information determined from other entities in system 100. In one embodiment, indicator 2332 may illustrate time periods of treatment access necessary to fulfill designated standards or guidelines. In another embodiment, indicator 2332 may illustrate when a patient must be transferred to another facility.

Indicator 2332 may illustrate time elapsed from an initialization until various subsequent steps are taken or must be taken. The initialization may include, for example, onset time, scene arrival time, or facility (door) arrival time. Such times may be automatically determined through options selected in critical condition module 1702 or through information inferred from the use of critical condition module 1702. Indicator 2326 may illustrate the time elapsed with regards to the current patient. The time required to get the patient to the facility from the time of first contact may be displayed in a way so as to contrast the time elapsed after the arrival of the patient at the facility.

Indicator 2332 may display the progress of the patient in relation to one or more care standards. In one embodiment, such a standard may include a requirement that a patient receive a PCI treatment—such as a catheter across a lesion—within ninety minutes of first contact. In another embodiment, such a standard may include a requirement that a patient receive a PCI treatment within ninety minutes of arriving at the hospital. In various embodiments, if the PCI treatment is not possible within the designated window, critical condition module 1702 may indicate to a user that an alternative procedure, such as thrombolytics, may be used. In such embodiments, the deadline for the treatment may require determining or factoring in the time to accomplish the PCI treatment. Furthermore, the deadline for the treatment may require determining or factoring in the time to move the patient to the laboratory for the PCI treatment. Such move time may include, for example, time necessary to move the patient form one facility to another as designated with options 2328, 2330. The total time required to transfer the patient to the laboratory for the PCI treatment, including any of these factors, may be designated as a. The transfer time a may change according to, for example, changing wait times or priorities for the laboratory, traffic, or other travel conditions. Given the transfer time a in indicator 2332, indicator 2332 may illustrate a required transfer designation at which point patient transfer must begin. If such transfer is not possible, alternative treatments are to be taken. As illustrated in FIG. 23, such an illustration may change depending upon which standard is used.

Furthermore, indicator 2326 may illustrate the average time required for a patient to be transferred. Such an average time may be established, for example, for a given network, facility or over a given time period. Upon completion of a transfer or another treatment-terminating event, performance may be evaluated and displayed in, for example, performance indicator 1816, if such performance meets display criteria.

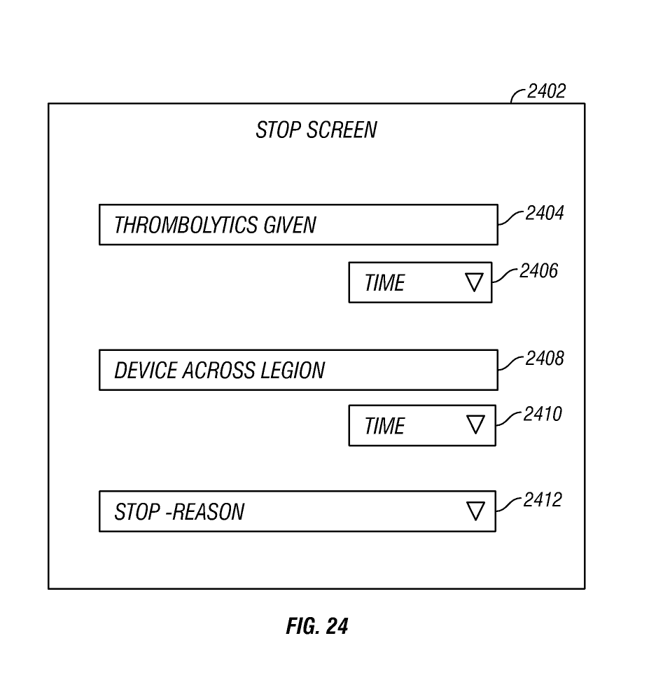

View 2302 may include an option 2334 to stop the instance of treatment. FIG. 24 is an illustration of a view 2402 for halting the monitoring of an active treatment of a patient using critical condition module 1702. View 2402 may be configured to halt the instance of treatment associated with, for example, a STEMI condition.

View 2402 may include any suitable number or kind of indications of why treatment—or at least monitoring of treatment—of a STEMI condition has been stopped. Such indications may include an indication that PCI treatment has been completed, or represent treatment options or outcomes that are mutually exclusive with the PCI treatment. For example, view 2402 may include an option 2404 to indicate that thrombolytics have been given to the patient. Such a treatment may be mutually exclusive to performing the PCI treatment. View 2402 may include an option 2406 to designate a time of such treatment. In another example, view 2402 may include an option 2408 to indicate that the PCI treatment, such as device across a heart lesion, has been performed. View 2402 may include an option 2410 to indicate the time of such a treatment. In yet another example, view 2402 may include an option 2412 to indicate that the STEMI treatment is being stopped. Option 2412 may include a designation of a reason why the treatment was stopped. For example, option 2412 may include choices to select that a contraindication to thrombolytics was determined, cadriogenic shock was observed, pulmonary edema was observed, or that medical contact was made less than sixty minutes before a balloon would have been able to have been applied.

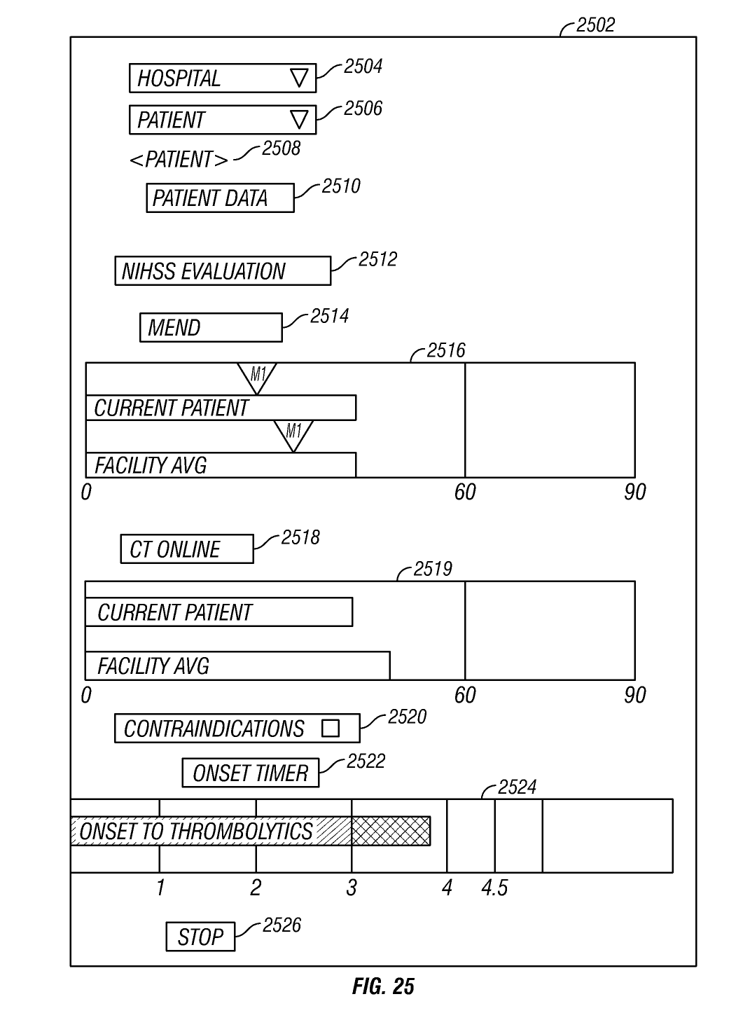

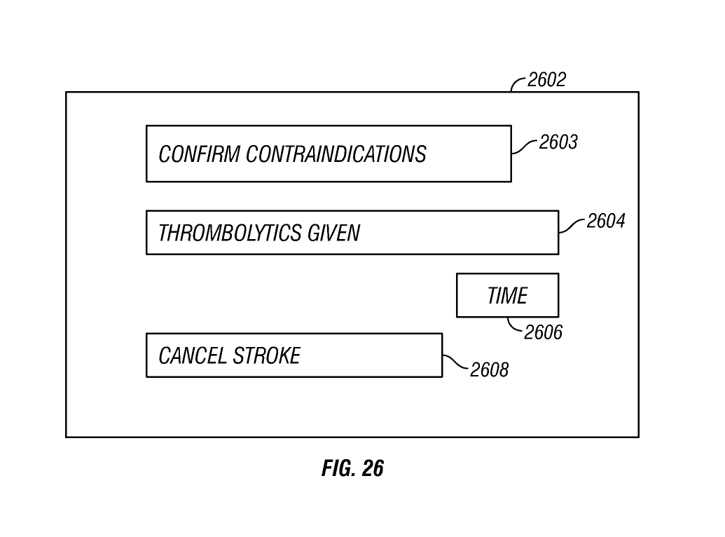

FIG. 25 is an illustration of a view 2502 of another instance of an active treatment of a patient using critical condition module 1702. View 2502 may be configured to illustrate treatment associated with, for example, a stroke condition.

View 2502 may include an option 2504 designating a chosen facility and an option 2506 designating the patient. Such options may be pre-populated from selections of view 2102. An indication 2508 may be displayed illustrating the chosen patient.

View 2502 may include an option 2510 for displaying or editing patient data. Such information may be populated according to information accessible by, for example, server application after a patient has logged in to system 100.

View 2302 may include any suitable mechanisms for entering preliminary diagnosis of the monitored condition, which may include a stroke. For example, view 2302 may include an option 2512 for entering an evaluation according to the National Institute of Health Stroke Scale (“NIHSS”). In another example, view 2302 may include an option 2514 for entering an evaluation according to the Miami Emergency Neurologic Deficit (“MEND”) examination. As applicable, use such options may be repeated for multiple examinations according to stroke evaluation practice. Option 2512 may include choices for designating a measurement of a range between zero and forty-two. Option 2514 may include choices for designating a measurement of a range between zero and twenty-two. Selection of a measurement may cause the resulting information to be entered into the patient's records as well as generating alerts to other users of critical condition module 1702.

Upon creation of a new treatment instance, measurement, or other action, alerts may be sent to other users of critical condition module 1702 or other applications of system 100. Such alerts may include, for example, alerts sent to neurologists, stroke teams, other physicians, or other specialists. Such users may be able to respond to alerts, which may be delivered to other instances of critical condition module 1702.

View 2502 may include an indicator 2516 of performance with regards to the performance of stroke evaluations such as those made through options 2512 or 2514. Indicator 2516 may illustrate time elapsed from an initialization until a stroke evaluation performed through, for example, options 2512 or 2514. The initialization may include, for example, onset time, scene arrival time, or facility arrival time. Such times may be automatically determined through options selected in critical condition module 1702 or through information inferred from the use of critical condition module 1702. Indicator 2516 may illustrate the time elapsed with regards to the current patient. In addition, indicator 2516 may indicate whether, and at what time, a given evaluation has been made on the timeline. If multiple evaluations have been made, each such evaluation may be placed on the timeline. A notation of the value of the evaluation (such as an integer) may be displayed on each evaluation on the timeline. Furthermore, indicator 2516 may illustrate the average time required for evaluations to be made. Such an average time may be established, for example, for a given network, facility or over a given time period. Upon setting of option 2512 or option 2514, performance may be evaluated and displayed in, for example, performance indicator 1816, if such performance meets display criteria.

View 2502 may include an option 2518 for illustrating whether or not a responsible physician, laboratory, or other specialized entity is prepared to receive the patient. In one embodiment, option 2518 may include a designation of readiness of a computed tomography (CT) scan team. Option 2518 may include the ability for a professional to activate readiness. Selection of option 2518 in such cases may acknowledge previously sent alerts. Furthermore, option 2518 in other instances of view 2502 used by other users of system 100 may be updated to reflect the new status. View 2502 may include an option contact the designated entity.

View 2502 may include an indicator 2519 of performance with regards to the activation of the designated readiness status. Indicator 2519 may illustrate time elapsed from an initialization until activation of the designated status by use of option 2518. The initialization may include, for example, onset time, scene arrival time, or facility arrival time. Such times may be automatically determined through options selected in critical condition module 1702 or through information inferred from the use of critical condition module 1702. Indicator 2519 may illustrate the time elapsed with regards to the current patient. Furthermore, indicator 2519 may illustrate the average time required for designated entities to set an active status. Such an average time may be established, for example, for a given entity, facility, network, or over a given time period. Upon setting of option 2518, performance may be evaluated and displayed in, for example, performance indicator 1816, if such performance meets display criteria.

View 2502 may include an option 2520 for selecting contraindications. Such contraindications may indicate that specific treatments, such as thrombolytics, are not to be given to the patient. Option 2520 may include any suitable kind or number or kind of contraindications according to standards for stroke treatment. For example, if an onset of symptoms began more than four and a half hours before treatment is possible, then use of thrombolytics may be excluded. Within a time period of zero to three hours after symptom onset, use of thrombolytics may be excluded if:
There is no diagnosis of ischemic stroke causing measurable neurologic deficit
Neurologic signs clear spontaneously
Neurologic signs are minor and isolated
Symptoms suggest or there is evidence of subarachnoid hemorrhage
Head trauma or prior stroke in past three months
Myocardial infarction in the past three months
Gastrointestinal or genitourinary hemorrhage in the previous twenty-one days
Arterial puncture in non-compressible site in the prior seven days
Major surgery in prior fourteen days
History of prior intracranial bleed
Systolic blood pressure over 185 mm Hg or diastolic blood pressure over 110 mm Hg
Evidence of acute trauma or bleeding
Taking oral anticoagulant and international normalized ratio over 1.7 (with option to enter prothrombin time value)
Taking heparin within past forty-eight hours and an abnormal activated partial thromboplastin time (with option to enter value)
Platelet count less than 100,000/μL
Blood glucose less than 50 mg/dL (2.7 mmol)
Seizure with residual postictal impairments
CT scan shows evidence of multilobar infarction (hopodensity over ⅓ hemisphere)
Patient or family do not understand the potential risks and benefits of therapy
   Additional customized contraindications may be allowed. Within a time period of three to four and a half hours after symptom onset, use of thrombolytics may be excluded if:
Patient is over eighty years old
Patient is taking oral anticoagulants, regardless of international normalized ratio
Patient has an NIHSS score greater than 25
Patient has a history of stroke and diabetes
   Additional customized contraindications may be allowed. In one embodiment, option 2520 may be automatically prompted to a user of critical condition module 2702 upon reaching contraindication milestones that may cause a different in available treatment options, such as the three-hour mark after symptom onset. Furthermore, option 2520 may include the ability to view selected contraindications.

View 2502 may include an onset timer 2522 indicating the amount of time elapsed since symptom onset. Furthermore, view 2502 may include an indicator 2524 for illustrating how much time is available before a specified treatment, such as thrombolytics, must be applied. Indicator 2524 may illustrate time elapsed from an initialization until various subsequent steps are taken or must be taken. The initialization may include, for example, symptom onset time and may be automatically determined through options selected in critical condition module 1702 or through information inferred from the use of critical condition module 1702. Indicator 2524 may illustrate the time elapsed with regards to the current patient.

Indicator 2524 may display the progress of the patient in relation to one or more care standards, such as time thresholds for applying thrombolytics. Such time thresholds may include, for example, three hours or four and a half hours. Given selection of contraindications that would preclude application of the treatment after a given threshold (such as preclusion of thrombolytics after three hours), indicator 2524 may show a deadline of the threshold. Selection of such a contraindication with option 2520 may thus adjust the display of indicator 2524.

View 2502 may include an option 2526 to cease treatment associated with the condition, or at least to cease monitoring of the treatment.

FIG. 26 is an illustration of a view 2602 of critical condition module 1702 once operation of view 2502 is to be ended.

View 2602 may include an option 2603 to confirm observed contraindications such as those provided by option 2520. Such observed contraindications may be confirmed as a justification to not apply a specified treatment, such as thrombolytics.

View 2602 may include an option 2604 to specify that a specified treatment, such as thrombolytics, have been administered. Furthermore, view 2602 may include an option 2606 to designate the time at which such treatment was applied.

View 2602 may include an option 2508 to confirm that the monitoring of the treatment is to be stopped. If no contraindication or thrombolytics administration time is specified, a user may be prompted to select one.

Returning to FIG. 17, upon selection of various options associated with critical condition module 1702, such selection may be recorded or transmitted in any suitable manner. For example, selection of an option in critical condition module 1702 may cause critical condition module 1702 to record the selection, forward the selection (or information thereof) to server application 102, or to forward the selection (or information thereof) to other applications such as other instances of critical condition module 1702 operated by users servicing the same patient. The selection may be recorded in the patient's records.

Any suitable number of instances of critical condition module 1702 may be coordinated for the treatment of a given patient. For example, a charge nurse at a hospital, an EMS technician, a stroke team, a catheter lab team, a CT lab team, an emergency physician, a cardiologist, and a neurologist may each be using an instance of critical condition module 1702. Once a patient has been entered into system 100 as active for a given condition, the patient may be assigned to such users. Actions taken by one of such users in an instance of critical condition module 1702 for the given patient may be communicated to the other users, as well as other associated health information.

All actions from various instances of critical condition module 1702 may be performed with a universal clock that is common to all such instances. Such a clock may be used to monitor times of, for example: symptom onset; medical contact—whether patient coming to a facility or EMS arriving at the patient's location; administration of a specific treatment such as thrombolytics, catheter, or CT scan (“flow time”); time leaving a location of a patient to transport the patient (“en route”); symptom onset to flow time; and arrival time at a facility with a patient who has been transported (“door time”). Specific time differentials, such as medical contact to flow time, medical contact to en route time, door to flow time, or medical contact to flow time may be measured, tracked, or aggregated by, for example, server application 104. Server application 104 may accumulate data that may identify areas of improvement. Such aggregation and analysis may be based on individual personnel, teams, facilities, networks, or geographic regions.

The use of indicators, such as indicator 2332, may be used by medical professionals to determine whether time is available to perform staggered or interim procedures. For example, a medical professional using critical condition module 1702 may utilize indicator 2332 to determine whether sufficient time exists to go to a first facility (wherein PCI is not available), apply thrombolytics, transfer to a second facility, and apply a PCI procedure to the patient, before a deadline. Furthermore, such a medical professional may utilize indicator 2332 to determine whether to go first to a facility with a PCI procedure available, whether no such PCI procedures are available before a deadline, or how long is available to attempt to reach interim procedures before leaving for a different facility.

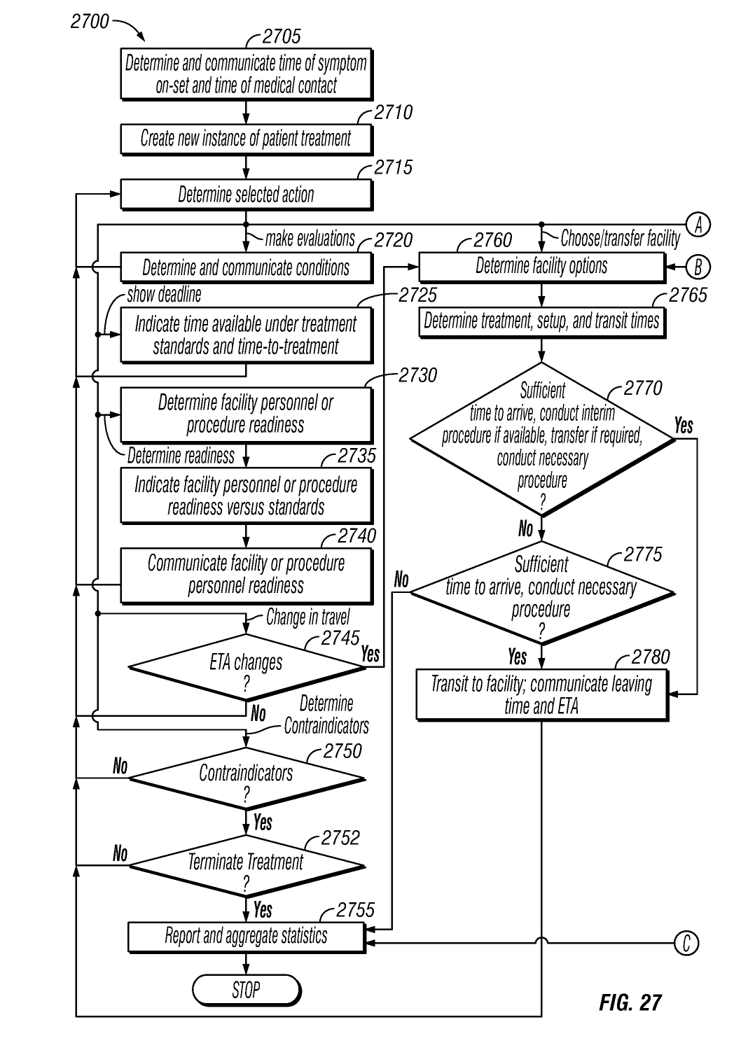

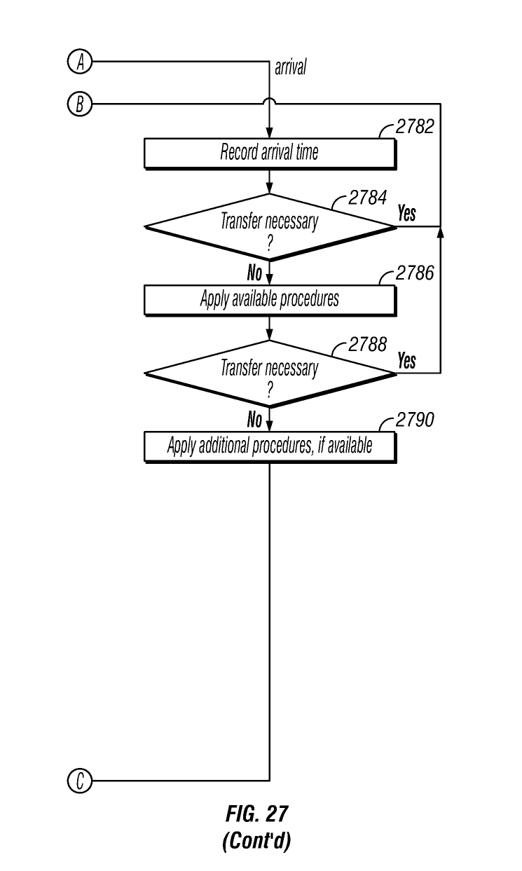

FIG. 27 is an illustration of an example embodiment of a method 2700 for performance of critical condition monitoring and evaluation. Different elements of method 2700 may be performed by various users of, for example, critical condition module 2702.

At 2705, a patient may be determined to have suffered or be experiencing a medical condition, such as a stroke or STEMI. A time of symptom on-set may be determined, recorded, and communicated, as well as a time of first medical contact. Such medical contact may include, for example, an EMS user. At 2710, a new instance of patient treatment may be created to be tracked amongst various users who will provide aspects of health services to the patient.

The ability to interactively assist the healthcare of the patient with regards to the condition may include various inputs and operations in parallel from different people or entities. Thus, one or more aspects of method 2700 are shown in parallel in FIG. 27. For example, at 2715, it may be determined what action, selection, or event has taken place. Based on such determinations, various other parts of method 2700 may be conducted. For example, if it is determined that a provider has made a measurement, evaluation, treatment, or other procedure, method 2700 may proceed to 2720. If is determined that information has been updated, actions taken, or time passed such that the present time in relation to a deadline has changed, then method 2700 may proceed to 2725. If it is determined that readiness of personnel, laboratories, equipment, or other entities have changed, method 2700 may proceed to 2730. If it is determined that a change in travel conditions has occurred, method 2700 may proceed to 2745. If it determined that contraindicators are to be determined or have changed, method 2700 may proceed to 2750. If it is determined that a facility is to be selected or a transfer is to be considered or performed, method 2700 may proceed to 2760. If transport of the patient has arrived at a facility, method 2700 may proceed to 2782.

At 2720, it may be determined whether evaluations, measurements, or other observations about the patient have been made. Such information may include, for example, an EKG, stroke indicators, or contraindicator information. The information may be stored or communicated to other participants of method 2700. The time of such information may be recorded. Indicators showing the measurements in view of a treatment timeline may be updated, if applicable. Method 2700 may return to 2715.

At 2725, the total amount of time elapsed since symptom on-set, medical contact, or facility may be illustrated in view of deadlines for various treatments, such as thrombolytics or PCI. Required times to prepare such treatments as well as transit time may also be determined and illustrated. The resulting illustration may include graphical indications of when treatments or transfers must be performed. The illustration may be made in view of standards or averages for treatment. Method 2700 may return to 2715.

At 2730, it may be determined whether readiness of personnel or procedures, equipment, or laboratories has changed. If so, in 2735, such readiness may be indicated versus standards or averages for such readiness. In 2740, the change in readiness may be stored or communicated to other participants of method 2700. Method 2700 may return to 2715.

At 2745, it may be determined that a change has occurred in travel conditions. Based on such a determination, it may be determined whether such conditions have resulted in a change in an estimated-time-of-arrival. Such a change may impact the ability of a caregiver to provide specific treatments. Thus, if there have been changes in estimated arrival times, method 2700 may proceed to 2760. Otherwise, method 2700 may return to 2715.

At 2750, contraindications may be determined. If no new contraindications have been determined, method 2700 may return to 2715. If new contraindications have been determined, in 2752 it may be determined whether such contraindications indicate that treatment is to be terminated. If treatment is to be terminated, method 2700 may proceed to 2755. Furthermore, the contraindications may rule out possible treatments by other elements of method 2700. In such a case, method 2700 may return to 2715 while preserving the treatment requirements determined in 2752.

At 2760, it may be determined that a facility is to be selected or a transfer is to be conducted or evaluated. Available facilities may be determined. At 2765, treatment options, setup times, and transit times for each such facility may be evaluated. At 2770, it may be determined, for a given facility, whether there is sufficient time to arrive at the facility (if necessary), conduct interim procedures if available (if necessary), transfer (if necessary), and perform any necessary procedures. If multiple such facilities match these conditions, the closest facility in terms of transit time may be selected. If so, method 2700 may proceed to 2780. If not, method 2700 may proceed to 2755. At 2780, transit to the facility may be initiated (if necessary). Furthermore, leaving time and estimated arrival times may be stored or communicated to other users. Method 2700 may return to 2715.

At 2782, it may be determined that arrival at a facility has occurred with the patient. The arrival time may be recorded or communicated to other users. At 2784, it may be determined whether transfer is necessary to, for example, perform necessary procedures. If so, method 2700 may proceed to 2760. If not, at 2786 available procedures may be applied, if applicable. Such procedures may include interim procedures such as thrombolytics for a STEMI patient. At 2788, it may be determined whether transfer is necessary to perform necessary procedures. If so, method 2700 may proceed to 2760. If not, at 2790, necessary procedures, such as thrombolytics for stroke patients or PCI for STEMI patients, may be performed. Method 2700 may proceed to 2755.

At 2755, statistics associated with the performance of method 2700 may be reported and aggregated. Method 2700 may stop.

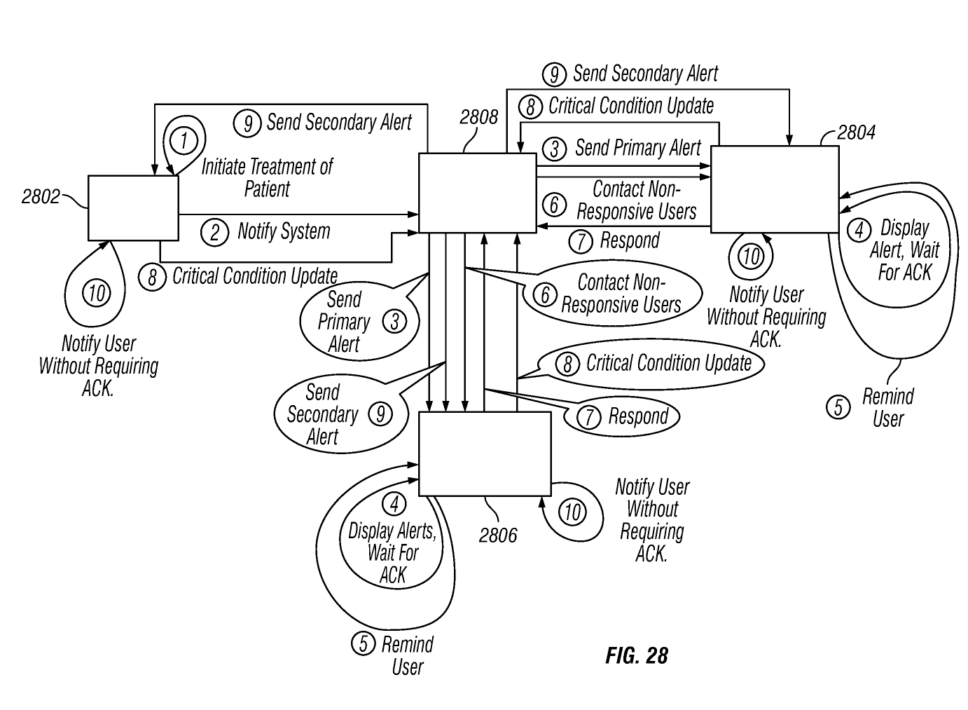

FIG. 28 is an illustration of example operation of system 100 configured to provide alerts in conjunction with condition-specific information tracking FIG. 28 illustrates the operation of instances 2802, 2804, 2806. In one embodiment, each of instances 2802, 2804, 2806 may include an instance of critical condition module 1702 operating on an electronic device for use by a healthcare professional. The specific number and kind of instances 2802, 2804, 2806 are shown in FIG. 28 for example purposes only, as any suitable number and kind thereof may be used. Any suitable combination of users may be associated with each of instances 2802, 2804, 2806. In the example of FIG. 28, instance 2802 may be used by an EMS professional, instance 2804 may be used by a physician specialist, and instance 2806 may be used by an operator of a lab or test equipment for a condition associated with a patient. The instances 2802, 2804, 2806 may be directed to a specific patient with a condition, such as a stroke or STEMI.

Any suitable mechanism or method may be used to coordinate the provision of alerts as shown in FIG. 28. In one embodiment, an instance 2808 of a module or application may be configured to coordinate such alerts. Instance 2808 may include an instance of, for example, server application 104. In another example, instance 2808 may include an instance of critical condition module 1702. In another embodiment, instances 2802, 2804, 2806 may directly communicate with each other regarding alerts. Instance 2808 may include web-accessible modules for displaying, reviewing, and managing alerts that are sent as discussed below.

At (1), at an instance of critical condition module 1702, treatment of a patient with regards to the condition may be initialized. Any of instances 2802, 2804, 2806 may so initialize treatment. In the example of FIG. 28, instance 2802 may initialize treatment. Initialization of treatment may correspond to, for example, use of option 1804. Upon initialization of treatment, primary alerts may be sent to other instances of critical condition module 1702 to which the patient is to be assigned. Such instances may include, for example, instances 2804, 2806.

Primary alerts may be sent to instances of critical condition module 1702 for which patient care coordination is required. Furthermore, primary alerts may require acknowledgment from a recipient. If acknowledgment is not received, the intended recipient may be contacted again through a same or different communication manner. If no acknowledgement is received, alerts about the unresponsive recipient may be sent to other entities, such as back-up personnel, supervisory personnel, or other coordinators of care of the patient.

At (2), instance 2802 may communicate the initialization of the care of the patient with other instances. In one embodiment, instance 2802 may send such a notification to instance 2808. In another embodiment, instance 2802 may send such notifications directly to instances 2804, 2806 in the form of alerts.

At (3), instance 2808 may send a primary alert regarding the patient and the condition to suitable recipients, such as instances 2804, 2806. At (4), the alert may be displayed or otherwise communicated on the individual instances 2804, 2806 to their respective users. Such display may include, for example, a pop-up notification, audible indications, changes to icons or other aspects of critical condition module 1702, or any other suitable notification. At (5), the notification may persist or repeat until an acknowledgment is entered by a user of instance 2804, 2806. Such repetition may have a time period of, for example, one minute.

At (6), if an acknowledgment has not been received in a specified time period from a given recipient instance 2804, 2806, instance 2808 may take any suitable corrective action. Instance 2808 may display, text, e-mail, or otherwise communicate to a user of instance 2808 that the user of the given instance 2804, 2806 has not responded to the primary alert. Instance 2808 may use alternative communication channels to contact a user of the given instance, such as text, e-mail, or a phone call, to alert them to the pending alert. Furthermore, instance 2808 may redirect the primary alert to another instance used by, for example, back-up personnel.

At (7), a recipient instance 2804, 2806 may respond with an acknowledgment entered by a user of the respective instance.

Subsequent actions may be taken by any of instances 2802, 2804, 2806. Such actions may include any determinations, selections of options, or other operations such as those described above in conjunction with critical condition module 1702. Any of such actions may generate a secondary alert to notify other instances associated with treatment of the patient as to the determination, selection, or other operation. Such secondary alerts may not necessarily require an acknowledgement from the recipient.

At (8), such an action may have been performed by one of instances 2802, 2804, 2806. The action may relate to some aspect of the critical condition of the patient or the treatment thereof. As such, the responsible instance may notify other of instances 2802, 2804, 2806 of the taken action. The responsible instance may notify others of instances 2802, 2804, 2806 by first notifying instance 2808. At (9), instance 2808 may send a secondary alert pertaining to the critical condition update to the others of instances 2802, 2804, 2806. At (10), each respective instance of 2802, 2804, 2806 receiving the secondary alert may notify a user of the respective instance. The alert may be displayed or otherwise communicated on the individual instances to their respective users by using, for example, a pop-up notification, audible indications, changes to icons or other aspects of critical condition module 1702, or any other suitable notification. In one embodiment, such a notification may be made without requiring acknowledgment.

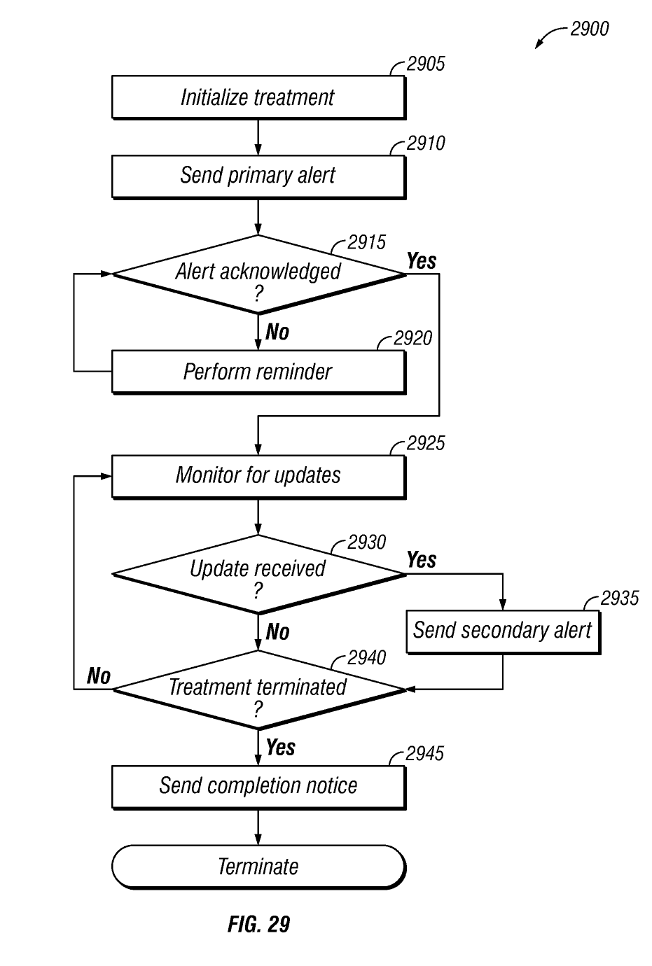

FIG. 29 is an illustration of example operation of a method 2900 for providing alerts in conjunction with condition-specific information tracking. At 2905, treatment of a patient may be initialized. The patient may suffer from, for example, a stroke or STEMI condition. At 2910, a primary alert may be sent to one or more instances of an application to be used by medical professionals who are to assist in the treatment of the patient. The set of medical professionals who may receive the alert may be defined by on-call or patient relationship status, the nature of the condition, and standards of care identifying the categories of such professionals whose efforts need to be coordinated. The alert may yield an indication to a user of a module for tracking treatment of the condition. The alert may include a request for acknowledgment. At 2915, it may be determined whether the primary alert has been acknowledged. If so, method 2900 may proceed to 2925. If not, at 2920 a reminder to the user of the module may be performed after a specified waiting period.

At 2925, monitoring may be conducted for any updates to the treatment or condition of the patient in relation to the condition. Such updates may originate from the entity that initialized treatment of the patient or from any entity that has been, in response to the initialization, associated with the treatment. Such other entities may include, for example, recipients of the primary alert. The updates may include transfer of the patient; changes in conditions of the patient; readiness of individuals, groups, or equipment to treat the patient; time elapsed since treatment benchmarks; reminders to move the patient to treatment or to another location; or other suitable information as described above.

At 2930, it may be determined whether such an update has been received. If such an update has not been received, method 2900 may proceed to 2940. If such an update has been received, in 2935 a secondary alert may be sent regarding the update. The secondary alert may be sent to recipients associated with the treatment of the patient with regards to the condition. In one embodiment, the secondary alert might not require an acknowledgment.

At 2940, it may be determined whether treatment of the condition has ended. If treatment is continuing, method 2900 may return to 2925. If treatment of the condition has ended, in 2945 an alert may be sent regarding the termination of treatment to recipients associated with the treatment of the patient. Method 2900 may terminate.

Although FIGS. 16, 27, and 29 disclose a particular number of steps to be taken with respect to example methods 1600, 2700, and 2900, methods 1600, 2700, and 2900 may be executed with more or fewer steps than those depicted in FIGS. 16, 27, and 29. In addition, although FIGS. 16, 27, and 29 disclose a certain order of steps to be taken with respect to methods 1600, 2700, and 2900, the steps comprising these methods may be completed in any suitable order. Methods 1600, 2700, and 2900 be implemented using the systems, embodiments, and examples of FIGS. 1-15, 17-26, and 28. In certain embodiments, methods 1600, 2700, and 2900 may be implemented partially or fully in software embodied in computer-readable storage media.

Although the present invention has been described with several embodiments, various changes and modifications may be suggested to one skilled in the art. It is intended that the present invention encompass such changes and modifications as fall within the scope of the appended claims.

What is claimed is:

1. A method for medical information communication, comprising:
determining a patient condition of a person presently experiencing the condition;
determining a timeline illustrating:
time lapsed since an initialization of treatment tracking;
a recommended treatment of the patient condition;
a treatment time necessary for effective application of a treatment for the patent condition; and
an average time of treatment;
indicating the timeline;
receiving real-time information regarding the condition; and
updating the timeline.

2. The method of claim 1, wherein the timeline further illustrates a transfer time including a time necessary to transport the patient to a location for conducting the treatment.

3. The method of claim 2, wherein the transfer time is determined according to real-time travel conditions.

4. The method of claim 1, further comprising determining and displaying a readiness indicator of a professional to conduct the treatment.

5. The method of claim 1, further comprising determining and displaying a readiness indicator of the treatment.

6. The method of claim 1, further comprising:
determining a measurement conducted in association with the condition; and
displaying an indication of the measurement on the timeline.

7. The method of claim 1, further comprising:
prompting a user for one or more contraindicators of the treatment of the condition; and
based on the contraindicators, adjusting the timeline.

8. The method of claim 1, further comprising:
upon initializing treatment, sending an alert to a plurality of user modules associated with the treatment;
determining whether the alert has been acknowledged in the plurality of user modules;
for each of the plurality of users that have not acknowledged the alert, issuing a reminder in the respective user module.

9. The method of claim 8, wherein the acknowledgment includes an indication that a user of the user module is prepared to participate in a portion of the treatment of the patient.

10. The method of claim 1, further comprising:
upon receiving real-time information regarding the condition, sending an alert to a plurality of user modules associated with the treatment.

11. An article of manufacture comprising:
a computer readable medium; and
computer-executable instructions carried on the computer readable medium, the instructions readable by a processor, the instructions, when read and executed, for causing the processor to:
determine a patient condition of a person presently experiencing the condition;
determine a timeline illustrating:
time lapsed since an initialization of treatment tracking;
a recommended treatment of the patient condition;
a treatment time necessary for effective application of a treatment for the patent condition; and
an average time of treatment;
indicate the timeline;
receive real-time information regarding the condition; and
update the timeline.

12. The article of claim 11, wherein the timeline further illustrates a transfer time including a time necessary to transport the patient to a location for conducting the treatment.

13. The article of claim 12, wherein the transfer time is determined according to real-time travel conditions.

14. The article of claim 11, further comprising instructions for causing the processor to determine and display a readiness indicator of a professional to conduct the treatment.

15. The article of claim 11, further comprising instructions for causing the processor to determine and display a readiness indicator of the treatment.

16. The article of claim 11, further comprising instructions for causing the processor to:
determine a measurement conducted in association with the condition; and
display an indication of the measurement on the timeline.

17. The article of claim 11, further comprising instructions for causing the processor to:
prompt a user for one or more contraindicators of the treatment of the condition; and
based on the contraindicators, adjust the timeline.

18. The article of claim 11, further comprising instructions for causing the processor to:
upon initializing treatment, send an alert to a plurality of user modules associated with the treatment;
determine whether the alert has been acknowledged in the plurality of user modules;
for each of the plurality of users that have not acknowledged the alert, issue a reminder in the respective user module.

19. The article of claim 18, wherein the acknowledgment includes an indication that a user of the user module is prepared to participate in a portion of the treatment of the patient.

20. The article of claim 11, further comprising instructions for causing the processor to, upon receiving real-time information regarding the condition, send an alert to a plurality of user modules associated with the treatment.

21. A system for medical information communication, comprising:
a processor;
a computer readable medium communicatively coupled to the processor; and
computer-executable instructions carried on the computer readable medium, the instructions readable by the processor, the instructions, when read and executed, for causing the processor to:
determine a patient condition of a person presently experiencing the condition;
determine a timeline illustrating:
time lapsed since an initialization of treatment tracking;
a recommended treatment of the patient condition;
a treatment time necessary for effective application of a treatment for the patent condition; and
an average time of treatment;
indicate the timeline;
receive real-time information regarding the condition; and
update the timeline.

22. The system of claim 21, wherein the timeline further illustrates a transfer time including a time necessary to transport the patient to a location for conducting the treatment.

23. The system of claim 22, wherein the transfer time is determined according to real-time travel conditions.

24. The system of claim 21, further comprising instructions for causing the processor to determine and display a readiness indicator of a professional to conduct the treatment.

25. The system of claim 15, further comprising instructions for causing the processor to determine and display a readiness indicator of the treatment.

26. The system of claim 21, further comprising instructions for causing the processor to:
determine a measurement conducted in association with the condition; and
display an indication of the measurement on the timeline.

27. The system of claim 21, further comprising instructions for causing the processor to:
prompt a user for one or more contraindicators of the treatment of the condition; and
based on the contraindicators, adjust the timeline.

28. The system of claim 21, further comprising instructions for causing the processor to:
upon initializing treatment, send an alert to a plurality of user modules associated with the treatment;
determine whether the alert has been acknowledged in the plurality of user modules;
for each of the plurality of users that have not acknowledged the alert, issue a reminder in the respective user module.

29. The system of claim 28, wherein the acknowledgment includes an indication that a user of the user module is prepared to participate in a portion of the treatment of the patient.

30. The system of claim 21, further comprising instructions for causing the processor to:
upon receiving real-time information regarding the condition, send an alert to a plurality of user modules associated with the treatment.
